(19) United States
(12) Patent Application Publication
(10) Pub. No.: US 2019/0314777 A1
(43) Pub. Date: Oct. 17, 2019

(54) METHODS FOR MIXING FLUIDS IN MICROFLUIDIC DEVICES, AND DEVICES AND SYSTEMS THEREFOR

(71) Applicant: FUJIFILM WAKO PURE CHEMICAL CORPORATION, Osaka (JP)

(72) Inventors: Zhi Li, Mountain View, CA (US); Yu Liu, Mountain View, CA (US); Henry G. Wada, Mountain View, CA (US); Daisuke Eto, Hyogo (JP); Chen Li, Mountain View, CA (US); Kazuhisa Kobayashi, Kanagawa (JP); Warren Wu, Mountain View, CA (US)

(21) Appl. No.: 16/465,658

(22) PCT Filed: Aug. 31, 2017
(86) PCT No.: PCT/IB2017/001153

§ 371 Date: May 31, 2019

Related U.S. Application Data
(60) Provisional application No. 62/428,906, filed on Dec. 1, 2016.

(30) Foreign Application Priority Data
Feb. 28, 2017 (JP) 2017-036399

(51) Int. Cl. B01F 13/00; B01L 3/00

(52) U.S. Cl. CPC B01F 13/0064; B01L 3/502738; B01L 3/50273

(57) ABSTRACT

Microfluidic devices, systems, and methods for mixing a solution are disclosed, comprising a microfluidic device (100) having a first chamber (110) connected via a connection channel to a second chamber (116) that in operation is only in fluidic communication with the first chamber of the device (100). In the method, solution in the first chamber (110) is forced into the second chamber (116), compressing the air trapped within the second chamber (116), and then that solution is returned to the first chamber (110). On return to the first chamber (110), the solution exits the connecting channel (115) and causes mixing in the first chamber (110).

### FIELD OF THE INVENTION

The invention relates to devices, methods, and systems for mixing a solution (a liquid) within a microfluidic device.

### BACKGROUND OF THE INVENTION

Microfluidic devices continue to be of great interest for conducting analyses of chemical and biological analytes. The terms “microfluidic” or “microscale” device generally refer to devices for manipulating fluids that comprise a network of microfluidic elements (e.g., channel, chambers, and other spaces for holding or moving liquids), in which at least one element has at least one dimension in the range of from about 0.5 jam to about 500 μm. For example, channels may have a depth and/or a width in this range, while a chamber may have at least a depth in this range.

Microfluidic devices enable small-scale reactions, which provide numerous benefits, such as reduced reagent usage, reduced sample size, and rapid operation, as is well known in the art. In addition, the integration of several functions within a single device is possible, wherein a sample may be transported from one device element to another for subsequent handling, reaction, or analysis. This aspect of integration in turn further enables improvements in sample throughput because of reduced sample handling by operators or robotic stations, smaller space requirements, and even portability for remote or field usage.

Assaying a sample generally requires contacting the sample with at least one reagent, allowing a reaction to proceed, and analyzing the result of the assay. Usually one prefers having a uniform concentration of the assay components in solution. Because fluid flow within a microfluidic device is generally not turbulent, a method for mixing the solution is needed. And, reaction kinetics may be improved by mixing the solution, such that convective transport occurs and one does not need to rely solely on diffusive transport.

The reduced sample size mentioned above also generally means that, because sample volumes are small, for a given concentration of analyte, the amount—the number of molecules of analyte—is correspondingly small. For certain analytical methods, as the absolute number of analytes becomes small, the results of the method may be less accurate. For example, values measured for replicate samples may have greater variation (standard deviation). This might arise for several reasons, such as the analyte initially might not be evenly distributed in the assay solution, reaction products such as amplicons might not be evenly distributed throughout the assay solution as the reaction progresses, and the portion of the solution that is measured in the detection step might not be representative of the assay solution.

It is generally recognized that diffusional mixing of molecules (reagents and/or assay products) in solution is slower than desired, even in microfluidic devices. Although the dimensions for sub-microliter volumes are small, diffusional mixing times for small molecules are on the order of several minutes, and the time to achieve homogeneous mixing of larger molecules (such as, for example, nucleic acids, enzymes, or proteins) or particles which have diffusion coefficients smaller by an order(s) of magnitude, would be substantially longer. As a result, those developing microfluidic devices have sought ways to enhance reagent mixing in the device. For example, Liu et al. (U.S. Pub. No. 2003/0175947 A1) disclosed a device for enhancing mixing using sonic waves or temperature changes applied to a gas pocket within a microfluidic chamber, wherein the gas pocket expands and contracts within a sound field or under the influence of temperature to result in an oscillating fluid flow in the device. Another example of a mixing technique was disclosed by Wang et al. (Biomed Microdevices, 12:533-541 (2010)) for mixing droplets within a second liquid phase in a microfluidic device.

Generally, however, these and other methods in the art still suffer from one or more of the following problems: (1) need for additional equipment or instruments that increase cost and space requirements; (2) incompatibility of analytes with two-phase systems; (3) inadequate mixing for larger volumes; and (3) introduction of other variations due to the mixing process, such as local temperature changes.

Accordingly, there remains a need for microfluidic devices, methods, and systems that provide for solution mixing within the device in order to achieve accurate, reproducible, and reliable analytical results; devices that are amenable to low cost and efficient fabrication and operation, including automation in a compact system, yet that are capable of processing a wide range of sample volumes, for example, from about 100 nL to about several milliliters or more, while decreasing operating costs.

### SUMMARY OF THE INVENTION

Devices according to the invention comprise a first chamber, a second chamber, and a connecting channel joining the first and second chambers, wherein the second chamber may be configured to have no outlets other than the connecting channel, that is, the second chamber is only in fluidic communication with the connecting channel when the devices are used in accordance with the methods described herein.

In one embodiment, a microfluidic device is provided, the device comprising a first chamber, a first load channel that leads from the first chamber to a first load well, a second load channel that leads from the first chamber to a second load well, a second chamber, and a connecting channel that leads from the first chamber to the second chamber. In preferred embodiments, the first chamber volume is between about 1 and 1 mL, the second chamber volume is at least about 0.1 and at most about 1.5 times the volume of the first chamber, wherein the second chamber fill ratio design parameter is at least about 0.2 and at most about 0.99. In the mixing methods of solutions described herein, the ratio of the volume of solution filling second chamber to the volume of second chamber as a result of raising the pressure over the load wells to P_{high} and thereby forcing solution from the first chamber to flow into the second chamber is referred to as the second chamber fill ratio (see discussion below). Also, in preferred embodiments, the connecting channel has a cross-sectional area between about 0.001 mm² and 0.12 mm².

In one embodiment, the product of (the second chamber fill ratio) x (the second chamber volume) is less than two times the lesser of (i) the volume of the first load channel plus the first load well and (ii) the volume of the second load channel plus the second load well. Accordingly, in this embodiment and others of the mixing methods of solutions, even upon raising the pressure over the load wells to P_{high} solution from the first and the second load channels will not completely empty and thereby permit air or other substances (e.g., silicone oil, etc.) to enter into the first chamber.

In another embodiment, the product of (the second chamber fill ratio) x (the second chamber volume) is less than the sum of (i) the volume of the first load channel plus the first load well plus (ii) the volume of the second load channel plus the second load well.

In some embodiments, the first chamber volume is between about 2 μL and 100 μL. In yet other embodiments, the second chamber volume is at least about 0.2 and at most about 0.95 times the volume of the first chamber. In further embodiments, the second chamber fill ratio design parameter is at least about 0.5 and at most about 0.7.

In some embodiments, the connecting channel has a relatively small cross-sectional area compared to at least the first chamber. In preferred embodiments, the connecting channel has a cross-sectional area between about 0.002 mm² and 0.06 mm².

In additional embodiments, a capillary electrophoresis channel network is connected to the first chamber. In these additional embodiments, one preferred embodiment comprises electrodes in the microfluidic device configured for electrophoretic analysis in the capillary electrophoresis channel network.

Methods for mixing a solution within a microfluidic device according to the invention comprise moving liquid from a first chamber into a second chamber via a connecting channel and then drawing liquid from the second chamber back into the first chamber. In some methods, as a consequence of the position, angle, and size of the connecting channel, solution exiting the connecting channel causes vortex mixing within the first chamber.

One embodiment comprises providing a microfluidic device as described by any of the embodiments described above, adding solution via the first load well to fill the first load channel, the first chamber, the second load channel, and the second load well, increasing the gas pressure over the first load well and the second load well to a pressure P_{high}, and then decreasing the gas pressure over the first load well and the second load well to a pressure P_{low}, wherein P_{low}, is equal to or greater than atmospheric pressure and less than P_{high}. In some embodiments, the gas pressure increasing step and the gas pressure decreasing step are repeated alternately at least two times.

Another embodiment comprises providing a microfluidic device as described by any of the embodiments described above, adding solution via the first load well to fill the first load channel, the first chamber, the second load channel, and the second load well, disposing a gas manifold block over the first and second load wells and sealing the gas manifold block against the microfluidic device. As described below, by disposing the gas manifold block over the device, the gas manifold block and the microfluidic device form an enclosed volume filled with gas, and this enclosed volume communicates with the external environment only via a port in the gas manifold block. Increasing or decreasing the gas pressure in the gas manifold block causes the gas pressure over the first load well and the second load well to increase or decrease. Thus, changes in gas pressure in the gas manifold block are transmitted to the volume of gas over the first load well and the second load well, such that increasing the gas pressure over the first load well and the second load well to a pressure P_{high}, and then decreasing the gas pressure over the first load well and the second load well to a pressure P_{low}, wherein P_{low}, is equal to or greater than atmospheric pressure and less than P_{high} is accomplished by increasing or decreasing the gas pressure in the gas manifold. In some embodiments, the gas pressure increasing step and the gas pressure decreasing step are repeated alternately at least two times.

In some embodiments of the above-mentioned methods, in the gas pressure increasing step, P_{high} is in the range of about 50 to about 200 kPa, and in some embodiments in the gas pressure decreasing step, P_{low}, is in the range of about 0 (atmospheric pressure) to about 180 kPa. Unless otherwise indicated, in this specification the pressure figures recited generally refer to a gauge pressure and not an absolute pressure, thus the recited pressures are zero referenced against the ambient, or, atmospheric pressure.

In some embodiments of the above-mentioned methods, in the gas pressure increasing step, the rate of increase is between about 20 kPa/sec and about 900 kPa/sec, and in some embodiments, in the gas pressure decreasing step, the rate of decrease is between about 50 kPa/sec and about 1500 kPa/sec. In some embodiments of the above-mentioned methods, the rate of gas pressure increase is between about 20 kPa/sec and about 100 kPa/sec, and the rate of gas pressure decrease is between about 100 kPa/sec and about 1000 kPa/sec.

Furthermore, in some embodiments of the above-mentioned methods, after the step of adding fluid, a water-immiscible fluid is placed on top of the solution in the first load well and the second load well. In preferred embodiments the water-immiscible fluid is silicone oil.

Systems are also provided comprising (i) a microfluidic device comprising a first load well and a second well, according to any of the above-mentioned device embodiments, and (ii) a gas manifold block comprising a first surface having at least one opening therein, a port on the outer surface of the gas manifold block that is not within the at least one opening, and a channel within the gas manifold block connecting the port to each of the at least one opening in the first surface, wherein the at least one opening in the first surface of the gas manifold block is disposed over the first and second load wells, and if present and according to the operational needs, over other wells of the microfluidic device. In such systems, the gas manifold block and the first and second load wells form an enclosed volume filled with gas that communicates with the external environment only via the port of the gas manifold block.

In some embodiments, the system further comprises a pressurized gas source, a valve comprising a first opening and a second opening, a first tube coupling the pressurized gas source to the first valve opening, and a second tube coupling the second valve opening to the gas manifold block port. In some preferred embodiments the pressurized gas source is a syringe pump or a regulated compressed air tank.

In some embodiments of the above-mentioned systems, the systems further comprise a microprocessor configured to control the increase and the decrease of pressure in the gas manifold block by controlling the source of pressurized gas and/or the valve.

In additional embodiments, the above-mentioned systems further comprise a temperature-controllable surface adapted to receive the microfluidic device.

In further additional embodiments of the system, wherein when the microfluidic device comprises a capillary electrophoresis channel network connected to the first chamber and electrodes in the microfluidic device configured for electrophoretic analysis in the capillary electrophoresis network, the system further comprises a power supply operatively connected to the electrodes in the microfluidic device.

These and other objects and features of the invention will become more fully apparent when the following detailed description of the invention is read in conjunction with the accompanying drawings.

### BRIEF DESCRIPTION OF THE DRAWINGS

FIGS. 1A and 1B each illustrate an embodiment of a device useful for performing embodiments of a mixing method.

FIG. 2 illustrates a device useful for performing mixing methods according to an embodiment of the invention that is integrated with a network of microfluidic channels.

FIGS. 3A, 3B, and 3C show designs for additional embodiments of a first chamber and a second chamber of a device useful for performing embodiments of a mixing method.

FIG. 4 illustrates the location of solution at two stages during an embodiment of a mixing method within an embodiment of a device.

FIGS. 5A and 5B each illustrate timing protocols for conducting mixing methods in conjunction with a thermocycled nucleic acid amplification reaction.

FIG. 6 illustrates an embodiment of a system comprising a microfluidic device and a gas manifold block.

FIG. 7 illustrates an embodiment of a system comprising a microfluidic device and a gas manifold block.

FIG. 8 illustrates an embodiment of a system comprising a microfluidic device and a gas manifold block.

FIGS. 9A-9C illustrate embodiments of a system comprising a microfluidic device and a gas manifold block.

FIGS. 10A and 10B each illustrate an embodiment of a system useful for controlling pressure within a device when performing an embodiment of a mixing method.

FIG. 11A shows the pressure measured within a device versus the pressure set points in an embodiment of a system illustrated in FIG. 10A. FIG. 11B shows the pressure measured within a device using an embodiment of a system illustrated in FIG. 10B, with and without actuating the valve.

FIGS. 12A-12F show capillary electropherograms for end-point analysis of PCR reactions described in Example 1, without mixing the sample (A-C) and with mixing the sample (D-F) according to an embodiment of the invention.

FIG. 13 shows the results of real-time RT-PCR analyses in a device according to an embodiment of the invention described in Example 2, wherein some samples were mixed according to an embodiment of the invention and some samples were not mixed.

### DETAILED DESCRIPTION

The devices, methods, and systems of the invention are generally useful for mixing a solution within a microfluidic device. Microfluidic devices are being designed and developed for conducting many different types of molecular biological or chemical reactions or assays. One of the driving principles is to have a device that can perform several different operations on a sample to obtain an analytical result. As noted above, the ability to mix solutions within the device provides numerous benefits when conducting such microscale assays.

One example is a bioassay based on a binding reaction involving a biomolecule, such as an antibody, protein, or nucleic acid. Such assays involve at least two molecules, and often more, to form a binding reaction product that can be detected, whether that detection is direct or indirect. If the assay involves an amplification reaction (e.g., PCR, and the like), the binding interaction needs to occur repeatedly throughout the assay. The accuracy, in terms of having the result properly reflect the concentration or copy number of analyte in the original sample, and the kinetics of the assay reaction generally depend on having the reaction occur in a uniformly mixed assay solution. Also, such assays usually need to be able to detect very low concentrations of an analyte, and thus uniform distribution of reaction product in the solution is needed to ensure that a representative solution aliquot is presented to the detector.

One particular application is real-time PCR analysis or quantitative PCR (qPCR) in a microfluidic device that at least comprises a reaction chamber in fluidic communication with a second chamber as described below. In the device, a sample is contacted with an oligonucleotide primer pair and the necessary reagents for a PCR reaction, such as for example a polymerase enzyme and deoxyribonucleotide triphosphates (dNTPs). The solution is thermocycled in the reaction chamber; it is subjected to repeated cycles of temperatures that support, respectively, denaturation of double-stranded polynucleotides, annealing of primers to the template, and extension of the primer into a polynucleotide product, also referred to as an amplicon. The original sample introduced into the microfluidic device may contain, for example, hundreds or only tens of copies, or fewer than ten copies of the target sequence. It can be appreciated that having a uniform distribution of the targets each time the assay is run is important for achieving an accurate, precise, and repeatable assay among different samples. According to various embodiments of the invention, it may be desirable to mix the sample (i) when the reagents are first brought into contact, (ii) at one or more time points or at regular intervals during the assay, and/or (iii) at the end of the reaction or incubation time.

In some embodiments, devices may further include microfluidic structures for detecting the reaction product (e.g., amplicon, and the like), such as a network of microchannels for conducting electrophoretic separations. Examples of devices that contain integrated reaction chambers and electrophoretic separation channels are disclosed in, for example, U.S. Pat. No. 8,394,324, by Bousse and Zhang, and U.S. patent application Ser. No. 14/395,239 (Pre-Grant Publication No. 2015/0075983), by Liu and Li, both of which are herein incorporated by reference, each in its entirety.

Thus the devices, systems, and methods of the subject invention also improve the devices, systems, and methods such as those disclosed by Bousse et al. or Liu et al. by enabling the efficient mixing of reaction and assay solutions within integrated devices that can perform an amplification reaction and measure the amount of amplicon (polynucleotide product) generated in the reaction, either by end point detection or real-time analysis during the course of the amplification.

Other related uses for the devices, methods, and systems disclosed herein include different types of nucleic acid amplification reactions. The targets may be either DNA or RNA sequences. The amplification reaction may be an isothermal process. Similarly, other uses include protein or antibody-based binding reactions to detect an analyte. One example of binding reaction assay is one for the analysis of hyaluronic acid, disclosed in U.S. patent application Ser. No. 12/578,576 by K. Sumida et al., “Method for measuring hyaluronic acid using hyaluronic acid-binding protein.” Such binding reaction assays are generally conducted under isothermal conditions. In these cases, the ability to mix may be all the more beneficial because there would likely be less contribution to solution mixing from heat-driven convective transport.

### A. MICROFLUIDIC DEVICES AND DESIGN PARAMETERS

Devices according to the invention comprise a first chamber, which may be generally referred to as a reaction chamber, and a second chamber, which may generally be referred to as a side chamber, connected by a connecting channel. In said devices, for each first chamber, one or more second chambers are provided, although one second chamber is preferred. The terms “reaction chamber” and “side chamber” are used solely to facilitate the discussion and are not intended to limit the devices, methods, and systems described herein. Generally, a solution is introduced into the device and conceptually, the portion of the solution in the reaction chamber is subjected to certain conditions over a period of time during which some reaction occurs. The reaction may be one or more of a binding reaction, a chemical reaction, an enzymatic reaction, an amplification reaction, and the like, according the purpose and type of assay or analysis. The reaction may occur in solution resident in other portions of the device, thus the terminology of “reaction chamber” is not intended to limit the invention or be determinative of where some reaction may or may not be occurring.

Before, during, and/or after the reaction period, the side chamber can be used to mix the solution resident in the reaction chamber. As will be described below, to mix the solution, fluid in the reaction chamber is forced through the connecting channel into the side chamber, and then the fluid in the side chamber is drawn back through the connecting channel and into the reaction chamber. The stream of solution exiting the connecting channel and entering back into the reaction chamber causes convective mixing of the solution in the reaction chamber, and possibly vortex flow within the reaction chamber to further mix the solution.

The side chamber serves this function as a result of the structure of the device. One aspect of the side chamber structure that supports this function is that in operation, the side chamber is only in fluidic communication with the reaction chamber, and that is only via the connection channel. More than one connection channel may be provided connecting the reaction chamber with the side chamber. In some embodiments, one connection channel is provided, in other embodiments, two or more connection channels are provided. In some embodiments, the device is fabricated having only one or more connecting channels providing fluidic communication to and from the second chamber. In other embodiments, the second chamber may be fabricated having other fluidic communication paths, such as channels, ports, and the like, although the device is capable of being configured such that, in operation, the second chamber is only in fluidic communication with the first chamber.

When the solution is first introduced into the device, the solution flows through and fills the reaction chamber but because gas (e.g., air) is trapped in the side chamber, the gas pressure prevents the solution from filling the side chamber. Thus, when not performing a mixing step, the pressure of the air trapped in the side chamber serves to keep the solution in the reaction chamber from freely moving into the side chamber. To perform a mixing step, first, pressure is applied to the airspace above the load wells to force the solution in the reaction chamber to move into the side chamber against the pressure of the trapped air, thereby compressing the trapped air. Then, the pressure in the airspace above the load wells is reduced, wherein the compressed air trapped in the side chamber now expands to push the solution out via the connecting channel into the reaction chamber.

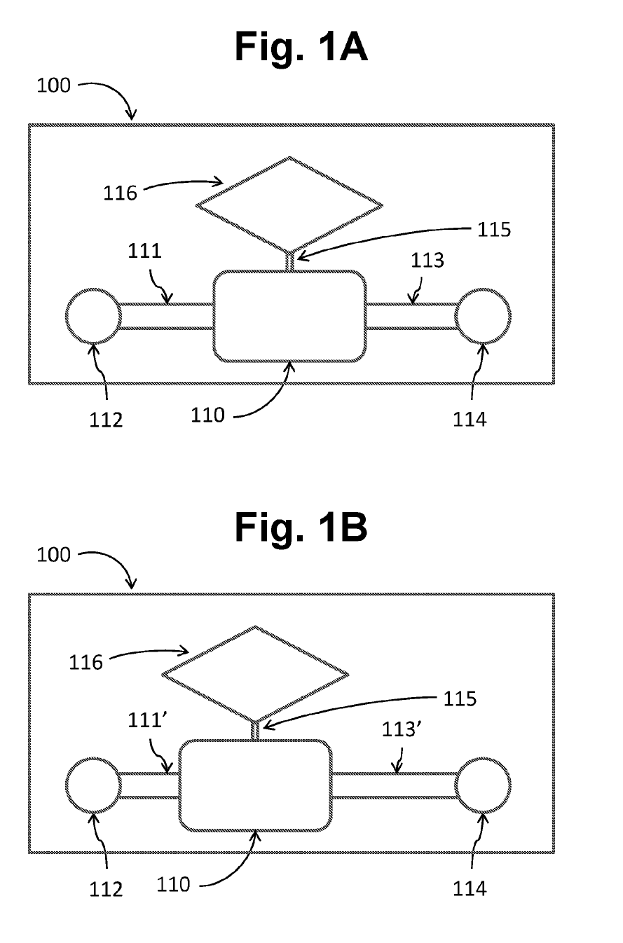

FIG. 1A illustrates an embodiment of a microfluidic device 100 according to the invention. The device comprises a first chamber 110, a first load channel 111 that leads from the first chamber 110 to a first load well 112, a second load channel 113 that leads from the first chamber 110 to a second load well 114, a second chamber 116, and a connecting channel 115 that leads from the first chamber 110 to the second chamber 116.

As illustrated in FIG. 1A, the load channels in some embodiments may be designed to have roughly equal dimensions. For example, the channel length from the well to the first chamber, the channel width, and the channel depth may be roughly the same for the first and second load channels. However, one preferred design consideration is the volume of the load channels between the load wells and the first chamber. Thus, if the channel volumes of the first and second load channels are roughly equal, for example, differ by no more than about 3%, the load channels can be considered, for design purposes, to be equal, even though one or more of the linear dimensions (length, width, depth) of each load channel may differ from one another.

FIG. 1B illustrates another embodiment of a microfluidic device 100 according to the invention. The device comprises a first chamber 110, a first load channel 111′ that leads from the first chamber 110 to a first load well 112, a second load channel 113′ that leads from the first chamber 110 to a second load well 114, a second chamber 116, and a connecting channel 115 that leads from the first chamber 110 to the second chamber 116. As illustrated in FIG. 1B, the load channels in some embodiments may be designed with unequal dimensions. In the figure, this is exemplified by a first load channel that differs in length from the second load channel. As a result, the channel volumes are different. The other channel dimensions (width and/or depth) may also differ between the load channels.

Whether the first and second load channel volumes are roughly equal or are different will affect the design of the second chamber's dimensions and the operating parameters of the mixing methods, as discussed below.

First chamber 110 is designed to have a volume of about 1 μL to about 1 mL. In some embodiments, first chamber 110 is designed to have a volume between about 2 μL and 100 μL. The volume of first chamber 110 can be sized according to the type of reaction conducted therein, and so that the reaction produces an amount of product sufficient to be analyzed, detected, or otherwise used. For example, if the reaction is an amplification reaction, such as polymerase chain reaction (PCR), the desired sensitivity of a PCR assay conducted in the device is a factor in setting the volume of the reaction chamber. If 10 target copies can be reliably amplified, and if the desired sensitivity is 1 copy per microliter, then the first chamber volume should be at least about 10 μL. A first chamber 110 having a volume of about 1, 2, 5, 10, 25, 50, 75, 100, 150, 200, 500, or 1000 μL is contemplated.

First chamber 110 may be designed to have support structures and/or fluid flow control structures. Support structures are often referred to as pillars or posts, and serve to support a film or laminate that enclose the chamber and prevent it from sagging down into the chamber. These are optional structures in the devices, but in embodiments where a chamber occupies a large enough area such that sagging may occur given the materials used to construct the device, it is preferred to have support structures that prevent sagging. In some embodiments, pillars or posts may provide other functionality instead of or in addition to supporting an enclosing surface, such providing a large surface area for binding reactions. Fluid flow control structures include weirs, grooves, and the like, that prevent bubble formation or promote filling of the entire volume of the chamber.

Second chamber 116 is designed to have a volume of at least about 0.1 and at most about 1.5 times the volume of first chamber 110. In some embodiments second chamber 116 has a volume of at least about 0.2 and at most about 0.95 times the volume of first chamber 110. The volume of second chamber 116 is sized to accommodate the amount (volume) of solution that will be forced in from first chamber 110 and the volume to which the trapped air will be compressed when the solution from the first chamber is forced in. The degree to which the solution will fill second chamber 116, and to which the trapped air is compressed will depend upon the force applied to the solution from outside the device. The greater the outside force, the more solution will fill second chamber 116, and the smaller the volume into which the trapped air will be compressed. The ratio of the volume of solution filling second chamber 116 to the volume of second chamber 116 is referred to as the “second chamber fill ratio.” For example, a second chamber fill ratio of 0.5 means that half of the second chamber volume will be occupied by solution when solution is forced in from first chamber 110 when performing the mixing method. In some embodiments the second chamber fill ratio is at least about 0.2 and at most about 0.99. In some embodiments the second chamber fill ratio is at least about 0.5 and at most about 0.7.

Connecting channel 115 is a channel of relatively small cross-section that provides fluidic communication between first chamber 110 and second chamber 116. Generally, the cross-section of connecting channel 115 is sized to have a higher hydrodynamic flow resistance than the load channels, and in embodiments of device 100 that comprise a capillary electrophoresis channel network, the cross-section is also sized to have a lower hydrodynamic flow resistance than the capillary electrophoresis channels. Thus, the cross-section of connecting channel 115 would be intermediate in size compared to a load channel and a capillary electrophoresis channel.

The cross-section of connecting channel 115 is generally less than about 0.12 mm². In some embodiments, the cross-section is less than about 0.06 mm². With no intent to be bound by theory, as the cross-section gets larger the flow rate of solution through connecting channel 115 in the mixing method decreases and the mixing becomes less efficient. And, as the cross-section gets larger, when solution is forced between the first chamber and the second chamber, there may be an increased tendency for bubbles to form in the solution. The cross-section of connecting channel 115 is generally greater than about 0.001 mm². In some embodiments, the cross-section is greater than about 0.002 mm². With no intent to be bound by theory, as the cross-section gets smaller the volumetric flow rate of the stream of solution exiting connecting channel 115 in the mixing method decreases and the mixing becomes less efficient.

There is not a clear transition from a cross-section that is adequate to one that is inadequate either because it is too small or too large, and the efficiency nonetheless depends on many factors such as the solution viscosity, the size and shape of first chamber 110, the aspect ratio of connecting channel 115 as well as the angle of entry of connecting channel 115 with respect to first chamber 110 (and its size and shape), the location and shape of any pillars or other structures within first chamber 110, and the like. Whether the cross-section of connecting channel 115 is adequate for a particular application can be determined by one of ordinary skill in the art in view of the results achieved with the device as further described below.

Regarding the aspect ratio (ratio of the depth to the width) of connecting channel 115, in some embodiments the ratio ranges from about 0.25 to about 4. In some embodiments, the ratio ranges from about 0.5 to about 2. The dimensions of the connecting channel, and thus the cross-sectional area and aspect ratio may vary over the length of the connecting channel.

Other design considerations regarding the connecting channel include its position and angle with respect to the first chamber. Generally, the connecting channel has an entrance position and entrance angle with respect to the layout of the first chamber that directs the solution exiting the channel to traverse a long path before striking a chamber wall or other structure within the chamber. The path does not have to be the longest unobstructed path within the first chamber, but the shortest paths through the first chamber are the least likely to provide thorough mixing throughout the chamber during a short mixing procedure. In some embodiments the path set forth by the design is long enough that the mixing effect obtained when performing methods according to the invention is sufficient for the intended application, as, for example, determined empirically as described in this specification.

The second chamber fill ratio is a design parameter that can be set by considering the amount of solution one desires to move in and out of second chamber 116, and the desired exit velocity of the solution leaving connecting channel 115 as it enters first chamber 110. The exit velocity will depend on many other factors, such as the dimensions of connecting channel 115 and the viscosity of the solution, but as a general principle, the exit velocity will be faster as the second chamber fill ratio is increased due to the greater compression of the air trapped in second chamber 116, provided the force applied to the solution outside the device is removed at a fast rate. The second chamber fill ratio may be limited by other factors, however, such as the ability of device 100 to maintain structural integrity under high internal pressure or the strength of the pressure source available.

Whether the amount of solution moving in and out of second chamber 116 and its exit velocity provides sufficient mixing of the solution can be determined empirically. For example, a dye or objects (e.g., beads, nanoparticles, etc.) can be introduced into the solution and their motion observed to determine the progress of the mixing process for different device structures and/or operating pressures. Those of ordinary skill in the art are familiar with methods for visualizing fluid flow within microfluidic devices. Or, sets of assays or analyses can be performed using different device structures and/or operating pressures and the results analyzed for evidence of homogeneity being achieved as a result of the mixing method. For example, the experiments described below in Examples 1 and 2 demonstrate the effect of mixing in achieving a more homogeneous solution and therefore obtaining results with a lower coefficient of variation.

Second chamber 116 is shaped such that solution is directed to move smoothly into and out of the second chamber and to minimize the likelihood that solution remains behind, which otherwise should be expelled via connecting channel 115. Accordingly, second chamber 116 is shaped to widen from the region where connecting channel 115 opens into second chamber 116. Viewed from the perspective of second chamber 116, the chamber narrows, or tapers, such that it acts like a funnel, to direct the solution into connecting channel 115. It is not required that second chamber 116 has the shape of a funnel or that the sides taper symmetrically towards connecting channel 115. Rather, the preferred design criteria is that as a result of second chamber 116 having such a “fluid-directing shape,” solution that enters the second chamber during operation of the mixing method is substantially expelled from the second chamber in the method. The invention does not require that 100% of the solution that enters be expelled, but that as a result of the “fluid-directing shape” design of second chamber 116, a substantial fraction of the solution is not left behind in the second chamber.

The amount of solution expelled in one mixing cycle might, in some instances, not equal the amount of solution that was forced in at the beginning of the mixing cycle due to differences between the applied force differentials (pressure differentials). If as a result some solution remains behind in second chamber 116, this does not detract from the design criteria that the solution that enters the second chamber is substantially expelled from the second chamber in the mixing method.

A second aspect of the design of second chamber 116 is that, in some embodiments, the portion of the second chamber where the interface between the solution and the trapped, compressed air is expected to be positioned, based on the second chamber fill ratio, has a cross-sectional area smaller than the characteristic cross-sectional area of the portion of the second chamber that fills with the solution during the mixing method. The characteristic cross-sectional area may be the maximum, the average, or the median cross-sectional area in that portion of the second chamber that fills with solution. In such embodiments, the cross-sectional area where the interface is expected to be positioned is about 80%, or about 60%, or about 40% or about 20% of the area of the characteristic cross-sectional area of the portion of the second chamber that fills with solution. In some embodiments, such as when second chamber 116 has a channel-like or tube-like structure, the cross-sectional area where the interface is expected to be positioned will be about the same dimension as the characteristic cross-sectional area in the portion of the second chamber that fills with the solution. Typically, the characteristic cross-sectional area is in the range of about 0.1 mm² to about 1.0 mm², in some embodiments it is in the range of about 0.1 mm² to about 0.5 mm². The cross-sectional area may be adjusted by varying the width and/or the depth of that portion of the second chamber. In some applications of the invention, such embodiments may be desirable in order to minimize the area of the air/liquid interface, and thereby minimize the effect of a temperature difference between the gas and liquid phases and/or other effects caused by the existence of the interface. Furthermore, in these embodiments, the distal end of second chamber 116, where the trapped air is compressed during the mixing method, may maintain the same smaller cross-sectional area as the portion where the interface is expected, become smaller, and/or become larger, and these changes may be achieved by changing the width and/or the depth of the second chamber.

The overall shape of second chamber 116 is not critical to the device design and operation of the mixing method, provided the second chamber embodies a fluid-directing shape, and the above design criteria for the various embodiments are met. Second chamber 116 may be chamber-like (for example, having a square-like or rectangular-like footprint) or channel-like (for example, having a width similar to that of the load channels) (or, equivalently, “tube-like”), or some combination of the two. The overall shape of second chamber 116 generally depends on the layout of the microfluidic device as a whole, and the area that is available for placement of the second chamber within the microfluidic device.

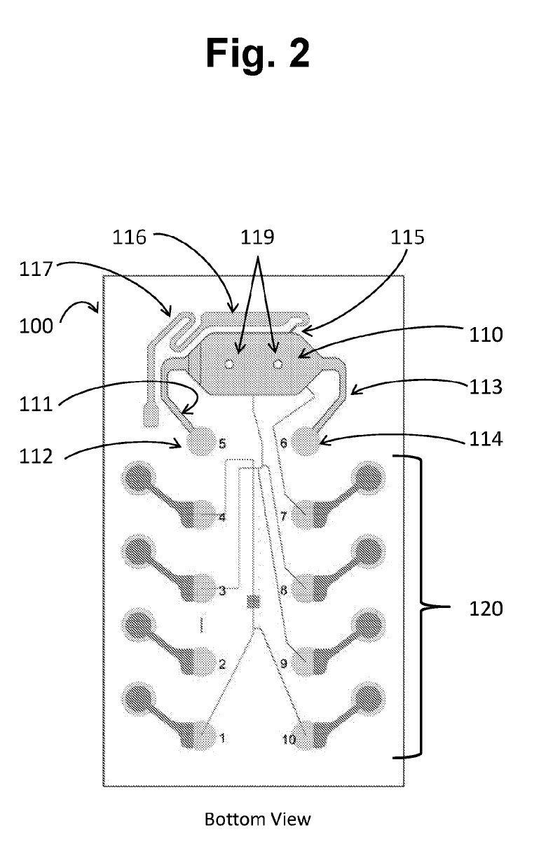

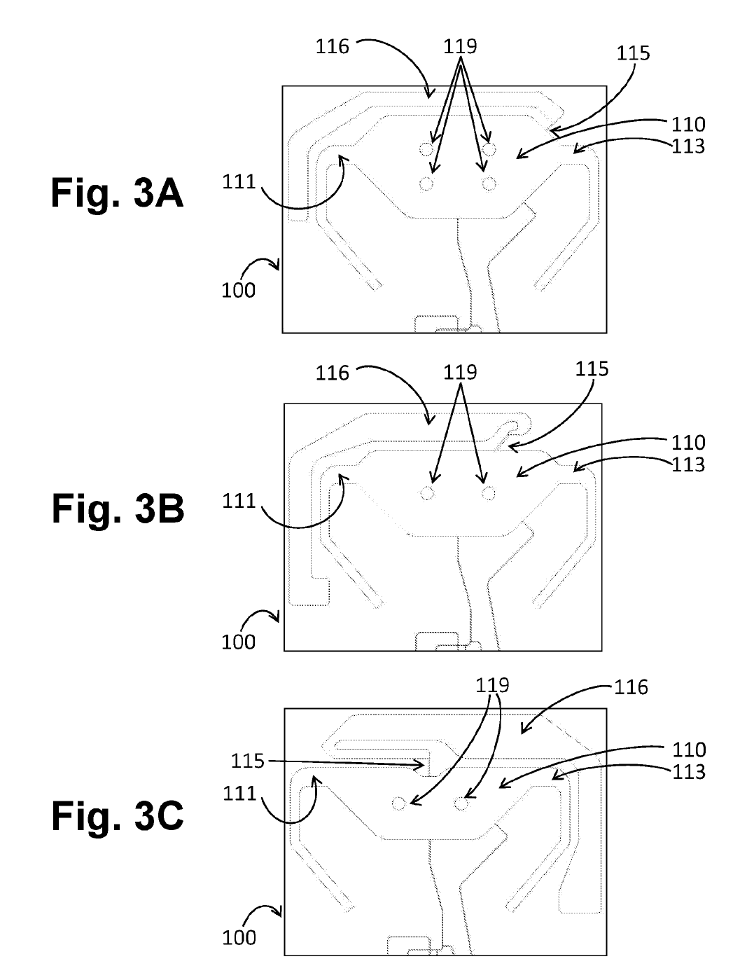

Examples of some design variations are shown in FIG. 2 and FIGS. 3A-3C. The structural elements in microfluidic device 100 of each figures are the same: device 100 comprises a first chamber 110, a first load channel 110, a second load channel 113, a second chamber 116, and a connecting channel 115. First chamber 110 further contains a plurality of support structures 119. FIG. 3A illustrates a second chamber 116 that has a footprint that is essentially channel-like or tube-like, with the connecting channel 115 joining the second chamber 116 at one end, and second chamber 116 extending around first chamber 110 while maintaining a characteristic width that does not substantially vary. Second chamber 116 in FIGS. 2, 3B, and 3C is also channel-like or tube-like, although these designs also incorporate areas that are broader.

In some embodiments, second chamber 116 is designed to minimize the combined footprint of first chamber 110 and second chamber 116, particularly if it is desired to control the temperature of the solution when it resides in and moves between the two chambers. When temperature control is desired, minimizing the footprint occupied by the two chambers minimizes the area needed for a temperature-controlled region, and this may be desirable for the precision and/or accuracy of the temperature control and/or the cost of the associated equipment.

The amount of solution one desires to move in and out of second chamber 116 also determines the structure of the first and second load channels (111, 113; or 111′, 113′) and the first and second load wells (112, 114). In operation, in preferred embodiments first chamber 110 remains full of solution even as solution is forced from first chamber 110 into second chamber 116 during the mixing method. To keep first chamber 110 full of solution, an adequate volume of solution must be available in load channels 111 and 113 or 111′ and 113′, and as necessary, in load wells 112 and 114.

The amount of solution that the first and second load channels and, as necessary, first and second load wells need to supply to first chamber 110 is equal to the amount solution that moves from first chamber 110 to second chamber 116. That volume can be expressed as (the second chamber fill ratio) x (the second chamber volume). Multiplying these two values gives the amount of solution that is forced to occupy second chamber 116, and as stated, in preferred embodiments of the device, the load channels and load wells are sized such that that amount of solution is available to be supplied to first chamber 110 from the load channels and load wells.

Typically, first and second load channels 111 and 113, or 111′ and 113′ have the same depth as first chamber 110, though the depth may vary along the length of the load channel. The load channels typically have a width of between about 50 μm and about 2000 μm, or between about 100 μm and about 1500 μm, and the width may vary along the length of the load channel. The length of the load channel is generally determined by considerations about the layout of the device, such as the size and spacing of the load wells, and the relative position between these features and the first and/or second chambers.

As noted above, in some embodiments first load channel 111 and second load channel 113 have roughly the same volume. In other embodiments, first load channel 111′ and second load channel 113′ have different volumes, typically due to having differing lengths.

Generally, the load channels have a relatively large cross-sectional area such that there is low hydrodynamic flow resistance, particularly to aqueous solutions. Thus, in operation, solution added to a load well tends to flow through the load channel and into the first chamber with no applied pressure. In some embodiments, however, a small pressure, e.g. less than about 7 kPa, may be applied to ensure the solution moves from a load well through the load channel and into the first chamber.

In some embodiments the first and second load channels have a volume between about 0.05 μL and about 50 μL. In other embodiments, the first and second load channels have a volume between about 0.1 μL and about 10 μL, and in other embodiments between about 1 μL and about 5 μL.

First load well 112 and second load well 114 are provided as access ports for introducing solutions into microfluidic device 100. The load wells each should have a large enough volume to hold an amount of solution sufficient to fill first load channel 111, first chamber 110, second load channel 113, as well as at least a portion of both first and second load wells 112 and 114. In preferred embodiments, for convenience, load wells 112 and 114 are designed to have the same size and structure, although this is not necessary. In some embodiments the first and second load wells have a volume between about 1 μL and about 1000 μL. In other embodiments, the first and second load wells have a volume between about 5 μL and about 100 μL.

Where the combined volume of the first load well and the first load channel differs from the combined volume of the second load well and the second load channel, such as illustrated in FIG. 1B, then the amount of solution available to be supplied to first chamber 110 in the mixing method is limited by the lesser of the two combined volumes. Thus, when considering the design criteria for device 100 in this circumstance, (the second chamber fill ratio) x (the second chamber volume) is less than two times the lesser of (i) the volume of the first load channel plus the first load well and (ii) the volume of the second load channel plus the second load well.

Where the combined volumes of the respective load well and load channel pairs are roughly the same, the design criteria for device 100 may be expressed as (the second chamber fill ratio) x (the side chamber volume) is less than sum of (i) the volume of the first load channel plus the first load well plus (ii) the volume of the second load channel plus the second load well. In these embodiments, each of the load channel and load well pairs can supply an equivalent volume of solution to first chamber 110, thus the design of the device can be expressed in terms of sum of the volumes of these microfluidic elements.

Devices according to the invention may further comprise other microfluidic elements. In particular, in some embodiments the devices further comprise channels and/or chambers useful for detecting chemical or biological components within. For example, in some embodiments a channel leads out of first chamber 110. Specific examples include the microfluidic networks for capillary electrophoretic analysis of the reaction components withdrawn from a reaction chamber in the devices disclosed in U.S. Pat. No. 8,394,324 to Bousse et al. Preferably, components are moved from the first chamber into the channel and then along the channel by electrophoretic transport. In some embodiments the channel is configured to have a region suitable for detecting components, such as an area suited for optical detection wherein the device material permits relevant wavelengths of UV, visible, and/or infrared light to pass in from a light source and out to a detector. In some embodiments, the channel may lead to a chamber wherein further processing or reactions are performed on the components transported in from first chamber 110. In other embodiments, the channel may lead to an exit port wherein solution components are removed for further use or analysis outside of the microfluidic device 100.

In still other embodiments, a channel leading out of first chamber 110 may deliver components from the first chamber to a capillary network optimized for the rapid analysis of sequential aliquots or samples removed from the first chamber. An example application is for real-time qPCR analysis. Such a capillary electrophoresis network is disclosed in U.S. patent application Ser. No. 14/395,239 (Pre-Grant Publication No. 2015/0075983), by Liu et al., which disclosure is incorporated herein by reference in its entirety.

FIG. 2 illustrates an embodiment of a device according to the invention comprising a first chamber 110, a first load channel 111 that leads from the first chamber 110 to a first load well 112, a second load channel 113 that leads from the first chamber 110 to a second load well 114, a second chamber 116, and a connecting channel 115 that leads from the first chamber 110 to the second chamber 116. Second chamber 116 further contains a chamber section 117 that has a smaller cross-sectional area than the portion of second chamber 116 situated closer to connecting channel 115. The device is designed such that given the relative volumes of first chamber 110, load channels 111 and 113, load wells 112 and 114, and second chamber 116, and the second chamber fill ratio, when solution is forced from first chamber 110 to second chamber 116, the air/liquid interface between the trapped, compressed air and the solution will be located within chamber section 117 of second chamber 116, as discussed above. First chamber 110 further contains two support structures 119 (e.g., pillars, posts, etc.), which serve to support a film or laminate. When such pillars or posts are present in the first chamber, the device is generally designed to have the connecting channel(s) not directing fluid into the pillars or posts. Thus, it is generally preferred though not required that the position and angle of any connecting channel is such that the main flow of the solution expelled from a connecting channel does not directly strike a pillar or post upon exiting the channel. The remainder of the microfluidic device elements 120 illustrated in FIG. 2, comprising capillary electrophoretic channel networks, wells, electrodes, detection region, and the like are described in U.S. patent application Ser. No. 14/395,239 by Liu et al.

FIG. 2 also illustrates an embodiment of device for performing the mixing method in which the volume of first chamber 110 is about 17 μL (including arms) and second chamber 116 is about 6.2 μL, thus the ratio of the first chamber to the second chamber is 2.7. FIGS. 3A-3C illustrate other embodiments having different relative sizes of the first and second chambers. In FIG. 3A, the volume of first chamber 110 is about 21 μL and second chamber 116 is about 6 μL, thus the ratio of the first chamber to the second chamber is 3.5. In FIG. 3B, the volume of first chamber 110 is about 18.9 μL and second chamber 116 is about 10 μL, thus the ratio of the first chamber to the second chamber is 1.9. In FIG. 3C, the volume of first chamber 110 is about 15.5 μL and second chamber 116 is about 14 μL, thus the ratio of the first chamber to the second chamber is 1.1.

Fabrication of microfluidic devices according to the invention generally involves preparing devices with fluidic features (e.g., channels, chambers) with different dimensions, particularly with different depths. For example, load channels 111 and 113 and first chamber 110 are typically about, e.g., 50-500 μm deep, in order to accommodate the necessary sample volume without requiring the other dimensions (width and length) to be excessively large. On the other hand, the capillary electrophoresis channel network typically comprises channels with a small cross-section that are less deep, e.g., 20-60 μm deep. By making the cross-section and the overall volume of the analysis channel network small, only a small fraction of the reaction solution needs to be removed for analysis and the large hydrodynamic flow resistance to entry into the channel network serves as a valve.

A microfluidic device could be made from any suitable material known to one skilled in the art. As disclosed in U.S. Pat. No. 8,394,324 to Bousse et al., methods for preparing such devices are known in the art. Polymethylmethacrylates and cyclic olefin polymers are suited to preparing channels of differing dimensions, including differing depths. The materials are selected for their compatibility with microfabrication techniques, which includes joining the materials to produce a device. For example, devices can be formed from polymer materials such as polymethylmethacrylate (PMMA), cyclic olefin polymers (COP) or cyclic olefin copolymers (COC), polycarbonate (PC), polyesters (PE), and other suitable polymers or elastomers, glass, quartz, and semiconductor materials, and the like.

Cyclic olefin copolymers (COC) are produced, for example, by chain copolymerization of cyclic monomers such as bicyclo[2.2.1]hept-2-ene (norbornene) or 1,2,3,4,4a,5,8,8a-octahydro-1.4:5,8-dimethanonaphthalene (tetracyclododecene) with ethene. Examples of COC's include Ticona's TOPAS® and Mitsui Chemical's APELTM COC's may also be prepared by ring-opening metathesis polymerization of various cyclic monomers followed by hydrogenation. Examples of such polymers include Japan Synthetic Rubber's ARTON and Zeon Chemical's Zeonex® and Zeonor®. Polymerizing a single type of cyclic monomer yields a cyclic olefin polymer (COP). PC, such as Mitsubishi's Lupilon® polycarbonate, and PMMA, such as Evonik CYRO's Acrylite® line of acrylates (e.g., S10, L40, M30) are suitable plastics for fabricating microfluidic devices.

Generally, such polymers are available in many grades. Depending on the application, an FDA-approved grade may be appropriate, though other types of grades may suffice. Other considerations regarding the choice of substrate for a microfluidic device include ease and reproducibility of fabrication, and low background in an optical measurement. These parameters can be readily optimized by those of skill in the art.

Typically, microfluidic devices that comprise a network of chambers, channels, and wells may be prepared from two or more substrate layers that are joined together to form a device. The manufacturing techniques for such devices, commonly referred to as microfabrication techniques, are well known in the art. In one example of a device preparation method, microfluidic chamber and channel features are microfabricated in the first surface of a substrate that comprises a first layer, and a second layer is joined to the first surface of the first layer in which the features were microfabricated to thereby enclose the features. Multilayered devices can also be prepared and are well known in the art.

In one embodiment, a device may be prepared by joining a polymeric thin film to a substrate first surface having a microfluidic network defined therein (i.e. a surface that presents trenches, indentations, grooves, holes, etc.) to thereby enclose the network. The thin film may have a thickness of about 20 μm to about 500 μm, or about 50 μm to about 200 μm. The thin film may be selected according to the uniformity of thickness, availability, ease of joining, clarity, optical properties, thermal properties, chemical properties, and other physical properties. Joining techniques include lamination, ultrasonic welding, IR welding, and the like, as are known in the art. The thin film material could be the same or different as the substrate to which it is joined. Any joining technique may be used to fabricate a device provided the finished device is able to withstand the operating pressure used in performing the methods described herein.

### B. METHODS OF OPERATION

Methods according to the invention are useful for mixing a solution within a microfluidic device. The methods are directed to the mixing of a solution within a first chamber in devices according to the invention. In some embodiments, the methods of the invention cause vortex mixing of solution in said first chamber.

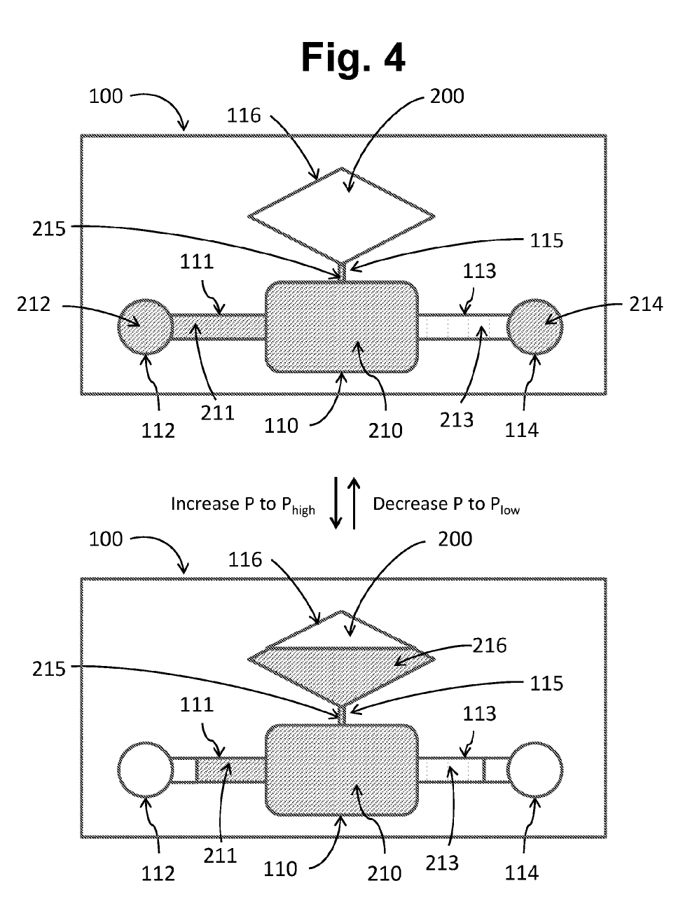

The movements of solution in embodiments of the method are illustrated in FIG. 4. Device 100 comprising structural elements 110, 111, 112, 113, 114, 115, 116 as described with respect to FIG. 1A is provided. In use, solution is introduced into device 100 via load well 112 or 114. In some device embodiments and/or some system embodiments load wells 112 and 114 can be used interchangeably, however in some embodiments, a device or a system might be designed to use one particular well for introducing solution into the device. For example, first chamber 110 may comprise structural elements such as weirs or grooves that suppress bubble formation or promote filling of the entire volume of the chamber during loading. Often such structures operate best when the solution is introduced from a particular direction. Or for example, device 100 may be designed for use in an automated or semi-automated system that includes a fluid management device that mates with the microfluidic device in a particular orientation, such that solution is introduced in one particular well in the system.

Assuming, for example, that solution is introduced into load well 112 (e.g., “first load well”), the solution flows through and fills load channel 111 (e.g., “first load channel”), first chamber 110, and load channel 113 (e.g., “second load channel”). The solution also enters load well 114 (e.g., “second load well”). Ultimately, the solution reaches hydrostatic equilibrium and fills load wells 112 and 114 to similar heights. The amount of solution introduced should be enough so that in performing a mixing method, at least some solution remains in load channels 111 and 113 when the solution is forced into second chamber 116. Also, when the solution flows through and fills load channel 111, first chamber 110, and load channel 113, some solution typically enters connecting channel 115. The degree to which solution flows into connecting channel 115 depends on the channel cross-section and length, the force used make the solution fill load wells 112 and 114, load channels 111 and 113, and first chamber 110, and the volume of second chamber 116. In preferred embodiments of the method, solution does not enter second chamber 116 during the solution adding process, but in some embodiments solution may enter second chamber 116. Allowing solution to enter second chamber 116 is generally avoided because this decreases the compression range within second chamber 116 in the mixing methods. To suppress entry of solution into second chamber 116, the dimensions of connecting channel 115 can be altered, such as by increasing the length or decreasing the channel cross-section. Other means, such as tailoring the surface properties of connecting channel to resist the advance of solution through the channel, such as by coating the channel surface with a hydrophobic material, can also be applied.

Adding solution, via the first load well, into the first load well, the first load channel, the first chamber, the second load channel, and the second load well can be accomplished, for example, by capillary action, hydrodynamic flow under gravity, or by applying a pressure to the solution. The pressure may be a positive pressure applied at the first load well to push the solution through to the second load well, a negative pressure applied at the second load well to pull the solution through to the second load well, or a combination of positive and negative pressures, whether applied during distinct and/or overlapping time periods. Also, the pressure may be positive pressure over both the first and the second load well simultaneously, wherein the solution will come into hydrodynamic equilibrium under the applied pressure. The capacity of the first load well should be large enough to accommodate a volume of fluid sufficient to fill the chamber and at least a portion of the two load channels. In preferred embodiments, the capacity of the first load well is large enough to accommodate a volume of fluid sufficient to fill the first chamber, the first and second load channels, and at least a portion of the first and second load wells.

Generally, in many embodiments an aqueous solution can fill the first chamber and reach the second load well by hydrodynamic flow under the force of gravity. When pressure is applied in the adding step, a positive pressure does not exceed about 35 kPa in some embodiments, and typically does not exceed about 7 kPa. Furthermore, the pressure is applied for a short enough time period that the solution will be properly positioned within the device and not, for example, forced out of the device. Thus, generally, the application of pressure is conducted according to a protocol determined ahead of time based on the solution volume and viscosity, device geometry, and the pressure control system to be used.

In the upper portion of FIG. 4, adding solution via first well 112 results in solution in the first load well (212), the first load channel (211), the first chamber (210), the second load channel (213), and in the second load well (214). Some solution may be present in the connecting channel (215) as a result of the adding step, as discussed above. Also as a result of the adding step, air (200) is trapped within the second chamber. Preferably, solution in the first load well (212) and the second load well (214) does not fill the entire volume of each load well 112 and 114.

In some embodiments, after the solution has been added to the device, a water-immiscible fluid is added on top of the solution in the first load well and the second load well. Preferably, an equal volume of the water-immiscible fluid is added to each load well. When a water-immiscible fluid is added to each load well, in preferred embodiments the entire volume of each load well 112 and 114 is not filled.

In some embodiments, the water-immiscible fluid is a hydrophobic polymer. The polymer may be an inorganic polymer, and a preferred embodiment is silicone oil (also known as silicone fluid). In some embodiments, the polymer may be an organic polymer, such as mineral oil, paraffin oil, Vapor Lock (Qiagen Inc., Valencia, Calif.), baby oil, or white oil. The polymer may be a natural, synthetic, or semi-synthetic product. The water-immiscible fluid is also preferably chemically and physically compatible with the method, the device materials, and the contents of solution added to the device. Those of skill in the art are familiar with the need for and methods for confirming the compatibility of a reagent, such as the water-immiscible fluid, with a microfluidic device and the assays, reactions, and analyses conducted therein.

Next, the gas pressure in the airspace above the first and second load wells is increased from an initial pressure to, for example, P_{high}. The initial pressure could be atmospheric pressure, or it could be a pressure above atmospheric pressure. As illustrated in FIG. 4, by increasing the pressure over the first and second load wells, the solution position changes from that shown in the upper portion to that shown in the lower portion of the figure. As illustrated, solution in the device is redistributed: solution (212 and 214) exits from the load wells, and solution (216) enters second chamber 116. Also, the air (200) trapped in second chamber 116 is compressed and occupies a smaller volume.

Subsequently, the gas pressure in the airspace above the first and second load wells is decreased from P_{high} to a lower pressure, for example, P_{low}. As a result of decreasing the pressure above the load wells, the compressed air (200) in second chamber 116 expands and forces solution (216) in second chamber 116 out via connecting channel 115 into first chamber 110 and ultimately solution (212 and 214) refills the load wells. P_{low}, may be the same or different from the initial pressure, and may be atmospheric pressure. In preferred embodiments, P_{low}, is greater than atmospheric pressure.

The steps of (i) increasing the gas pressure above the first and second load wells followed by (ii) decreasing the gas pressure above the first and second load wells may be repeated as many times as desired. Generally, the steps of increasing and decreasing the gas pressure are repeated enough times to achieve the desired amount of mixing of the solution.

The illustration in FIG. 4 shows that solution exits the load wells and only partially occupies the first and second load channels as a result of increasing the gas pressure over the load wells. In other embodiments (not illustrated), the volume of solution in the first and second load wells (212 and 214) compared to the volume of solution (216) that is forced into second chamber 116 is enough that, for the given design of the device 100 and the volume of each microfluidic element, even at P_{high}, solution (211 and 213) completely fills the first and second load channels and solution (212 and 214) at least partially fills the first and second load wells. In such embodiments, when a water-immiscible fluid is added on top of the solution in the load wells, the water-immiscible fluid will remain in the load wells and not enter the load channels.

As mentioned, the two steps of increasing and decreasing the gas pressure are repeated enough times to achieve the desired amount of mixing of the solution. Furthermore, in using a device 100 for performing reactions, assays, or other analyses, a mixing protocol may be conducted before, after, and/or any number of times during the reaction, assay, or other analysis. In some embodiments where a reaction is performed in the device, and particularly when the reaction is a nucleic acid amplification reaction, such as PCR, the mixing protocol may be performed at one or more points during the amplification reaction (after the amplification protocol starts but before it concludes). Each time a mixing protocol is performed, the number of times the two steps of increasing and decreasing the gas pressure are repeated may differ, according to the needs of the procedure.

The time gap between the gas pressure increasing and decreasing steps may vary. In some embodiments, the gas pressure decreasing step occurs soon after the increasing step, such as within 2 seconds or less, or within 60 seconds or less of the gas pressure increasing step, such that the solution is passed into and out of the second chamber to perform the mixing, but is mainly resident in the first chamber. In other embodiments, the solution may be passed into the second chamber and remain there for a substantial period of time during the assay before being expelled back into the first chamber.

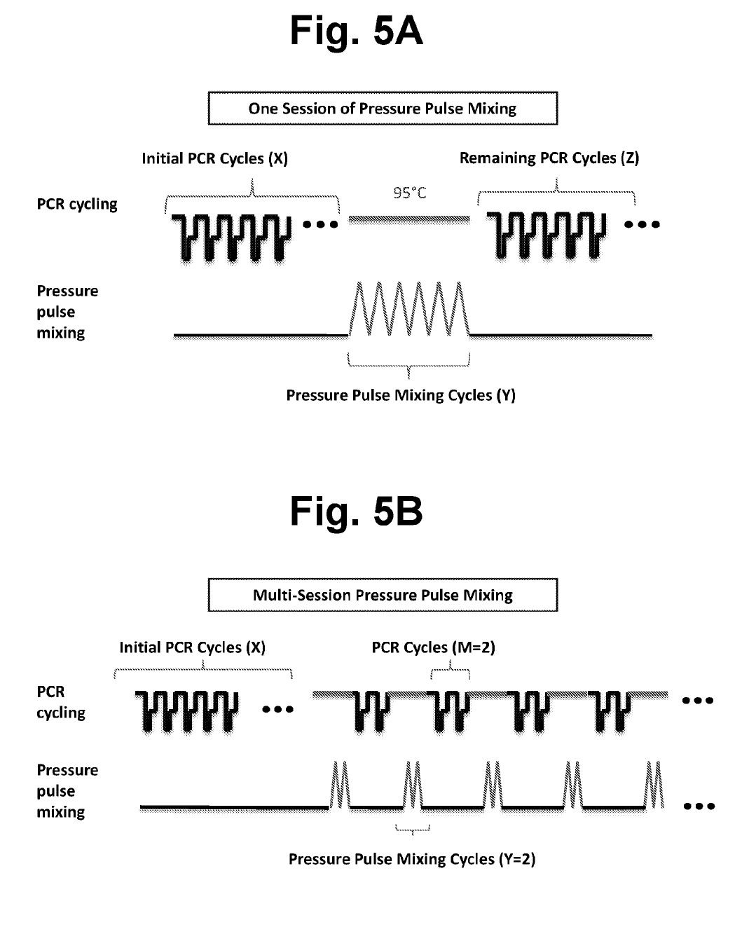

Two examples of pressure pulse mixing protocols are illustrated in FIGS. 5A and 5B. In FIG. 5A, one session of pressure pulse is conducted during the course of a PCR amplification reaction. When a mixing process is performed in conjunction with an assay in which the temperature is varied, such as PCR, it is preferred that the mixing process be performed while the temperature is held steady. Thus, for example, an initial set of temperature cycles may be performed X times, then, while the temperature is held steady, pressure pulse mixing cycles may be performed Y times, and then the remaining PCR cycles may be performed Z times. In this example, the sum X+Z is generally the typical number of PCR cycles, which will vary according to the application as is well known in the art. In assays analyzing for the presence or absence of nucleic acid material of an infectious organism for examples, 30-50 cycles are commonly performed.

In some embodiments, the pressure pulse mixing steps may be performed at the beginning of the assay (e.g., X=0) if it is desired to ensure the assay analytes are uniformly distributed at the beginning of the assay. In some embodiments, the pressure pulse mixing steps may be performed at the end of the assay (e.g., Z=0), if it is desired to ensure that the assay products are uniformly distributed at the end of the assay reaction, for example, before the product detection step. In some embodiments, the pressure pulse mixing steps may be performing in the middle of the assay (e.g., X#0, Z#0) if it is desired to ensure that the assay reaction intermediates are uniformly distributed throughout the solution and not clustered in reaction zones.

The number of pressure pulse mixing cycles (Y) may be as few as 1 and as many as 2, 3, 4, 5, 6, or 8 or 10 or 20 or 30 times, or more. The number of mixing cycles that are useful will depend on many factors, such as the geometry of the device, including the relative sizes of the first and second chambers, the size and angle of the connecting channel, the second chamber fill ratio, the magnitude of the pressure change applied, the solution viscosity, and the like, and can be determined readily for each device and application. When determining the number of mixing cycles, one may also take into account the total assay time, and allocate the time used for mixing steps accordingly in balancing total assay time versus the needs for mixing the solution.

In other embodiments (not shown in FIG. 5A), pressure pulse mixing cycles may be performed in more than one session. For example, the solution may be mixed before and after the assay protocol, before and during the protocol, during and after the protocol, or before, during and after the protocol. When mixing is performed during the protocol, it may be performed at one or more different time points during the protocol. For example, it may be performed half-way and three-quarters of the way through the protocol. If the protocol involves discrete cycles, such as temperature cycles, as used in PCR protocols, mixing may be performed after every cycle, every second cycle, or every third or fourth cycle, for example. FIG. 5B illustrates an embodiment where, after an initial set of cycles are performed X times (X may vary from 0 to about 40 or more), a set of pressure pulse mixing cycles are performed after every second cycle. Two mixing cycles (Y=2) are illustrated, though the number of cycles may be adjusted, as discussed above. In some embodiments this may continue through to the end of the assay protocol.

Other aspects of the method, including how the gas pressure over the load wells may be controlled, are described in conjunction with system components in the next section.

### C. SYSTEM COMPONENTS

In one embodiment, a microfluidic device system for mixing solution in said device comprises a microfluidic device as described in this specification, and a gas manifold. Generally, a gas manifold is an apparatus that fits over the microfluidic device and allows for controlling the gas pressure over the wells of the microfluidic device. In some embodiments it further allows for simultaneously controlling the gas pressure over all of the wells of the device. In some embodiments, this is done by exposing all of the wells to the same common, confined space, whereby controlling the pressure of that common, confined space results in all the wells experiencing essentially the same gas pressure.

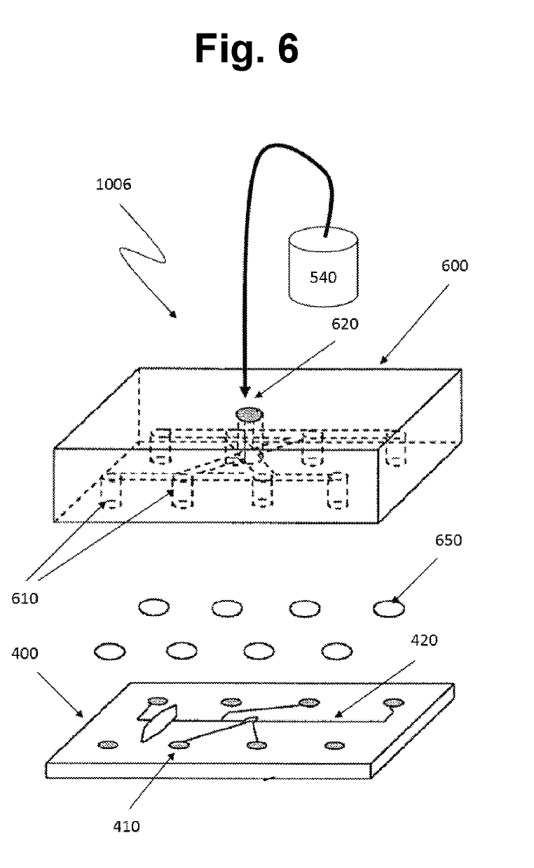

Some embodiments of a gas manifold comprise a manifold block having at least one opening in a first surface. The gas manifold also comprises a port on an external surface that communicates with the manifold. The first surface of the gas manifold mates with the microfluidic device such that the at least one opening in the first surface forms an enclosed space over both the first and second load wells. The port on the external surface can be coupled to a pressure source. An exemplary embodiment of a system useful for practicing the invention that includes a gas manifold block is shown in FIG. 6. FIG. 6 shows an exploded view of a microfluidic device system (1006), which comprises a gas pressure source (540), a gas manifold block (600), a plurality of first surface openings (610), a port (620), gaskets (650), microfluidic device (400), which includes wells (410) and a microfluidic channel network (420).

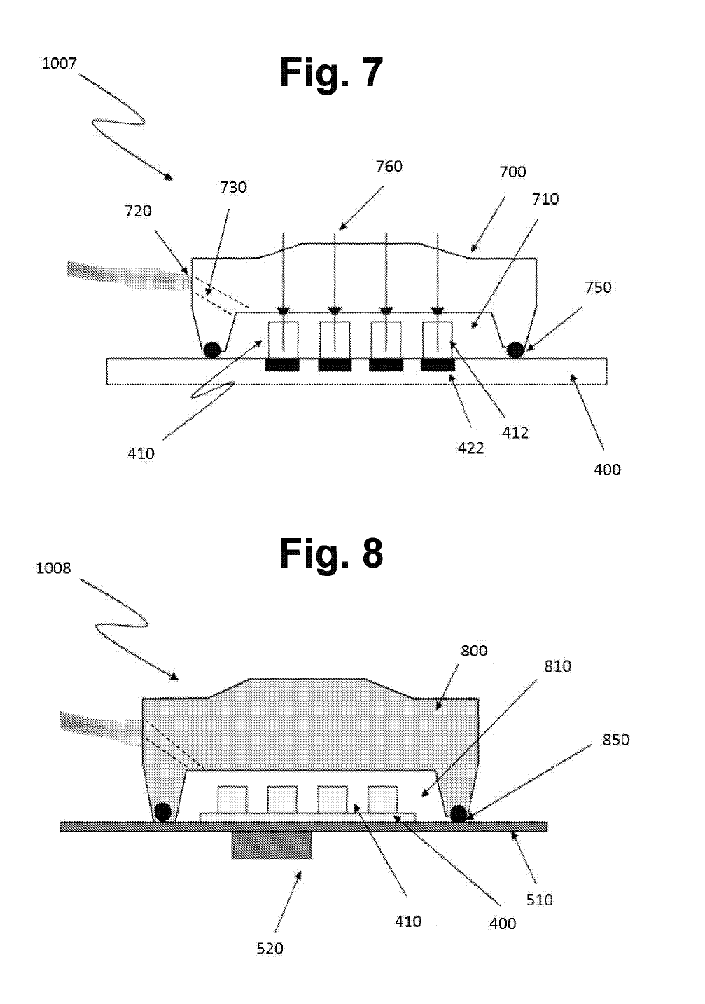

In one embodiment, the gas manifold has a single opening in the first surface that encloses a space over both the first and second load wells. The first surface may contact and form a seal against the upper surface of the microfluidic device on an area that surrounds the first and second load wells. Where other wells are present in the microfluidic device that communicate with channels that ultimately communicate with the first and second load wells, in preferred embodiments the single opening in the first surface also encloses a space over all the wells that are interconnected by microfluidic channels with the first and second load wells. Exemplary embodiments of systems comprising a gas manifold block with a single opening are shown in FIGS. 7 and 8. FIG. 7 shows a cross-sectional view of a microfluidic device system (1007) in which the manifold block (700) is disposed against the surface of microfluidic device (400). Gas manifold (700) includes a port (720) and a manifold block channel (730) leading from port (720) to opening (710) in the first surface of manifold block (700). Manifold block (700) may be optionally fitted with electrodes (760) that pass through the block and descend into liquid held in the wells (410), which comprise tubular extension (412) atop well trench (422) of the device (400). A gasket (750) is shown fitted between manifold block (700) and device (400). FIG. 8 shows a cross-sectional view of a microfluidic device system (1008) in which the manifold block (800) is disposed against base plate (510), wherein the microfluidic device (400) with wells (410) is placed on base plate (510) within opening (810) in the first surface of manifold block (800). A gasket (850) is shown fitted between manifold block (800) and base plate (510), and thermal cycling element (520) is positioned beneath base plate (510) and a specific portion of microfluidic device (400) for controlling the temperature of a reaction solution placed therein.

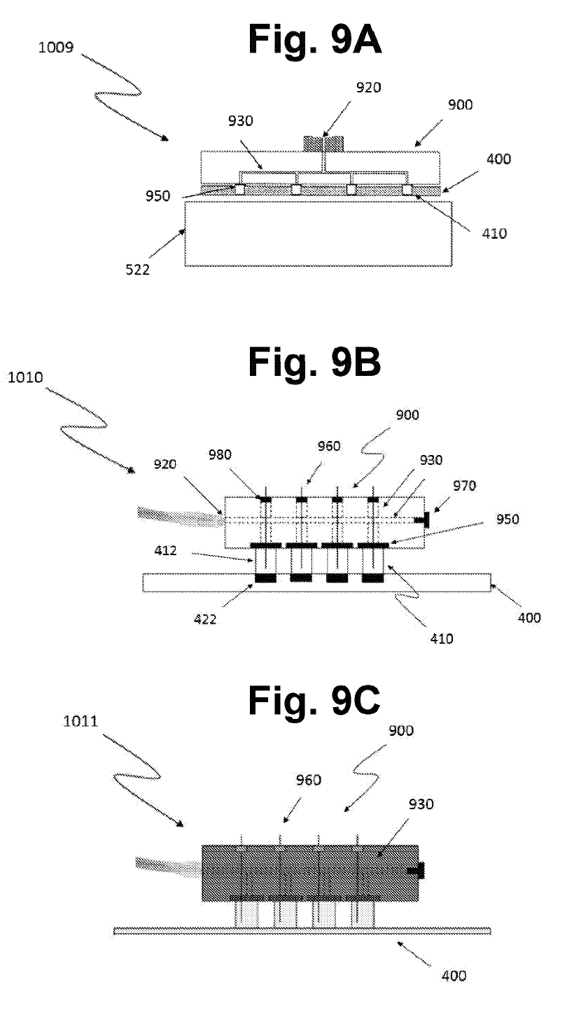

In another embodiment, the gas manifold has a plurality of openings in the first surface, wherein the openings each mark the ends of channels of an interconnecting channel system within the gas manifold block. This interconnecting channel system also connects to a port on the external surface of the gas manifold, and the port can be coupled to a gas pressure source. The plurality of openings in the first surface align with the first and second load wells when the gas manifold is disposed on the microfluidic device. The openings in the first surface may contact and form a seal against the surface of the microfluidic device surrounding each load well or, if a tubular extension surrounding (and in part defining) the well is present, against the surface of the extension (also known as a “raised rim”). Where other wells are present in the microfluidic device that communicate with channels that ultimately communicate with the first and second load wells, in preferred embodiments additional openings in the first surface also align with each of the wells that are interconnected by microfluidic channels with the first and second load wells. The gas manifold may have a separate opening that aligns with each of the other wells, or in some cases two or more wells may be covered by the same opening. Exemplary embodiments of systems comprising a gas manifold block with a plurality of openings are shown in FIGS. 9A, 9B, and 9C. FIGS. 9A-9C show a cross-sectional view of microfluidic device systems (1009, 1010, 1011), respectively, in which the manifold block (900) is disposed against the plurality of wells (410) of microfluidic device (400). Gas manifold (900) includes a port (920) and a manifold block channel (930) leading from port (920) to a plurality of openings in the first surface of manifold block (900) that align with wells (410). Manifold block (900) may be optionally fitted with electrodes (960) that pass through the block and descend into liquid held in the wells (410), which may comprise tubular extension (412) atop well trench (422) of the device (400). A plurality of gaskets (950) is shown fitted between manifold block openings in the first surface and the plurality of wells (410) of device (400). FIG. 9A further illustrates a thermal cycler element (522) positioned beneath device (400) for controlling the temperature of a reaction solution placed therein. In FIG. 9B, plug (970) and epoxy plug (980) are shown as exemplary means for sealing openings in manifold block (900) should they be present as a result of the manufacturing process. FIG. 9C illustrates an alternative manifold design comprising electrodes (960) that pass through the manifold body (900) but do not pass through the manifold block channel (930), as illustrated in FIG. 9B.

In any embodiment of a gas manifold, a compressible material may be present where the gas manifold contacts the microfluidic device to facilitate formation of a tight seal between the gas manifold and the microfluidic device. The compressible material may also be in the form of a gasket or O-ring to facilitate the formation of a tight seal along the perimeter of one or more areas between the gas manifold and microfluidic device that establish a confined, common space over the load wells.

By securing a gas manifold against the microfluidic device and controlling the gas pressure supplied to the manifold from a pressure source connected via the port, the pressure over the first and second load wells may be increased and decreased. By increasing and decreasing the pressure over first and second load wells, one may perform a mixing method according to the invention.

By way of example, some embodiments of gas pressure manifolds useful for controlling the pressure over the wells of a microfluidic device are disclosed by Li et al. in U.S. patent application Ser. No. 12/600,171 (Pre-Grant Publication No. 2010/0200402), which is herein incorporated by reference in its entirety. Li et al. further disclose systems and methods using such gas manifolds with microfluidic devices for performing molecular biological assays, which, for the avoidance of doubt, are also herein incorporated by reference.

The gas supplied to the gas manifold for controlling the pressure over the load wells may be air, nitrogen, argon, or other similar gases that are compatible with the materials of the devices and the chemical (biochemical) components of solutions introduced into the microfluidic device.

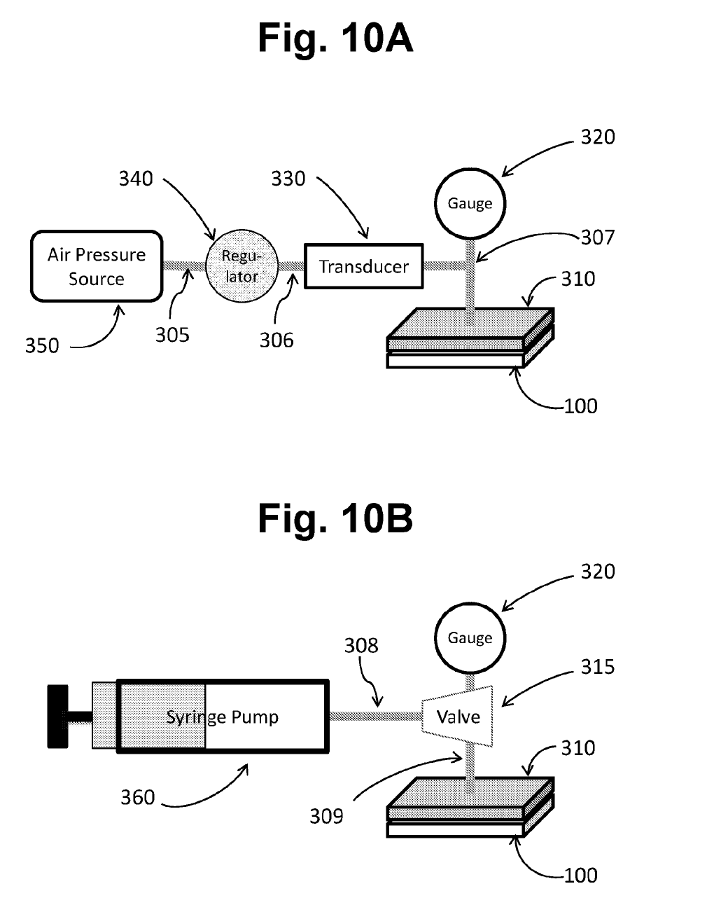

FIGS. 10A and 10B illustrate two exemplary embodiments of a microfluidic device system for mixing solution in said device comprising a microfluidic device 100 and a gas manifold 310. The system of FIG. 10A further comprises a gas pressure source 350 connected via conduit 305 to a pressure regulator 340, which is connected via conduit 306, transducer 330, and conduit 307 to gas manifold 310. Transducer 330 controls the pressure downstream in conduit 307 by receiving an electrical input signal from a computer (not shown) and producing a regulated output pressure proportional to the signal received. Thus, a pressure profile, a series of pressure set points as a function of time, may be sent from a computer to the transducer to generate a series of pressure cycles. Transducer 330 can be used to produce a higher pressure in conduit 307 (e.g. up to that set by regulator 340), or to produce a lower pressure (by venting). Pressure gauge 320, also connected to conduit 306 provides a visual readout and/or electronic signal of the pressure in the conduit. Conduits 305 and 306 can be made from any material as long as it is sufficiently rigid to withstand the pressure differentials applied to the system. Each conduit may be made of the same or different materials. Commonly used materials include metals and engineering plastics, but any of the materials used in the art may be selected. Gas pressure source 350 may be any source of high pressure gas such as a gas compressor, “house” pressure source, or a compressed gas tank.

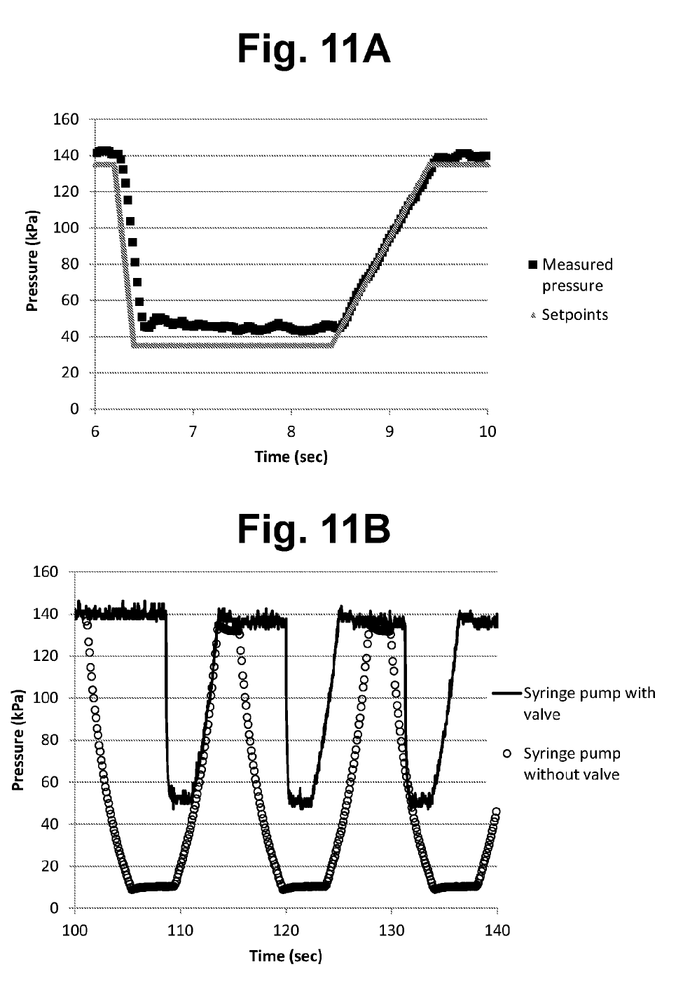

In operation, the system of FIG. 10A may be used by controlling the pressure set at the regulator to increase and decrease the gas pressure within the system. Starting from a high pressure state, decreasing the pressure regulator set point and bleeding the pressure down to the set point pressure reduces the pressure in the confined, common space over the load wells in the system. Conversely, starting from a low pressure state, increasing the pressure set by the regulator causes a pressure increase in the confined, common space. Experimental data illustrating the pressure change in such a system as a function of time is shown in FIG. 11A. The figure compares the pressure set points with the observed pressure within the confined, common space and thus over the load wells of the microfluidic device. The figure shows an excursion between a high pressure (set point) of about 135 kPa and a low pressure set point of about 36 kPa. The transition time from high to low pressure was about 0.25 seconds and from low to high pressure was about 1 second. The rate of change in pressure will depend primarily on the speed of pressure regulation, among other factors.

The system of FIG. 10B further comprises syringe pump 360 connected via conduit 308 to valve 315, which is connected via conduit 309 to gas manifold 310. Pressure gauge 320 may optionally be connected to valve 315 via a conduit. Instead of a pressure gauge, a third port could be used to vent the system, or the third port could be capped, rendering the valve equivalent to a two-port valve. The materials of conduits 308 and 309 are as described above for conduits 305 and 306. The syringe pump may be any standard syringe designed to withstand pressures of up to about 200 kPa. The syringe may be glass or plastic. The syringe is sized such that the volume change achievable can provide the necessary pressure difference desired for a mixing method. For example, where the volume of the enclosed space of the system (including the syringe pump, tubing, and device) is about 28.5 mL, a syringe with a volume of 26 mL can be used to drive pressure changes (e.g., P_{high}−P_{low}=200 kPa). In such a case, the volume change in the syringe is about 18 mL. A standard motor is used to drive the plunger of the syringe. Typically, the linear force of the motor driving the plunger is at least about 13 pounds. Numerous motorized syringe pumps are commercially available, and are suitable for use with the systems described herein.

In operation, the system of FIG. 10B may be used by actuating the syringe pump to increase and decrease the gas pressure within the system. Starting from a high pressure state, moving the plunger outwards increases the volume within the confined, common space over the load wells in the system and thus causes the pressure to decrease. Conversely, starting from a low pressure state, moving the plunger inwards decreases the volume of the confined, common space and thus causes the pressure to increase. Experimental data illustrating the pressure change in such a system as a function of time is shown in FIG. 11B in the curve labeled “Syringe pump without valve” (◯). The figure shows repeated excursions between a high pressure of about 140 kPa and a low pressure of about 10 kPa. The transition time from high to low pressure was about 5 seconds and from low to high pressure was about 4 seconds. The rate of change in pressure will depend primarily on the drive rate of the syringe plunger and the volume of the confined, common space, among other factors.

One means for imparting a faster rate of change in pressure on the system is to actuate a valve, such as valve 315, in conjunction with the syringe pump. The valve may be any standard valve for use with gas fluids, which, for example, may be manually or electromechanically operated. In some embodiments, the valve is a solenoid valve, and the valve may be computer-controlled. Further, the valve operation is coordinated with the syringe movement, as described below, to provide the pressure changes useful for performing the methods according to the various embodiments of the invention. The valve may be a two-port valve connecting the syringe with the airspace over the first and second load wells of a device. In some embodiments, the valve may be a three-port valve, connecting the syringe, the airspace over the first and second load wells of a device, and, for example, a pressure gauge or an exhaust line to the atmosphere. The valve connection is configured such that the airspace over the device may be alternately connected to the syringe and the gauge/exhaust.

Using both a syringe pump and valve and starting from a high pressure state in the confined, common space of device 100, gas manifold 310, conduits 309 and 308, and syringe pump 360, first, valve 315 is closed, and then the plunger is moved outwards, increasing the volume and decreasing the pressure within syringe pump 360 and conduit 308. Then, valve 315 is opened, and the pressure over the load wells in device 100 will decrease as the pressure equalizes throughout the confined, common space. Conversely, starting from a low pressure state, valve 315 is closed, the syringe plunger is moved inwards to decrease the volume and increase the pressure in syringe pump 360 and conduit 308. Then, valve 315 is opened, and the pressure of the load wells of device 100 will increase as the pressure equalizes throughout the confined, common space.

In some embodiments, the syringe pump and valve are coordinated for the transition from a high pressure state to a low pressure state, but not during the reverse (low to high pressure transition) process. By coordinating the syringe pump and the valve, the gas pressure decreasing step is accelerated and the transition occurs at a faster rate that it would otherwise using only a syringe. It is during this step that solution from the second chamber is expelled into the first chamber, and it is typically observed that the mixing is more pronounced when the transition rate is faster. On the other hand, the gas pressure increasing step is performed with the valve open between the syringe and the device and only actuating the syringe.

Experimental data illustrating the pressure change in such a system as a function of time is shown in FIG. 11B in the curve labeled “Syringe pump with valve” (-). The figure shows repeated excursions between a high pressure of about 140 kPa and a low pressure of about 55 kPa. The transition time from high to low pressure was about less than 1 second using the valve in conjunction with the syringe to produce a fast transition rate, and from low to high pressure was about 3 seconds using just the syringe. Using a valve in conjunction with the syringe pump should result in faster pressure rate changes provided the opening time of the valve is faster than the drive rate of the plunger. In either of these operational modes, to obtain the desired pressure change the necessary volumetric change in the syringe pump can be determined based on the volume of solution to be displaced into the second chamber.

Embodiments of the system may be combined with other equipment or control systems that interface with the microfluidic device, the gas manifold, gas pressure source, or pressure control system.

### D. EXAMPLES

### Example 1. Post-PCR Assay Mixing

A. PCR Primers and Target

A 243-base pair segment of phiX174 RF1 DNA (New England Biolab, MA; Cat. No. N3021S) was used as the PCR amplification target. The forward primer was labeled with a fluorescent dye (TAMRA) for detection. The primer sequences were:

(forward primer):
SEQ ID NO: 1
5′-TAMRA-cgttggatgaggagaagtgg-3′
(reverse primer):
SEQ ID NO: 2
5′-acggcagaagcctgaatg-3′

A PCR assay reaction mixture was prepared with the following components: 1×KOD buffer, 0.25% CHAPS, 0.1 mg/mL BSA, 0.4 mM dNTP, 0.095% sodium azide, 1.25 U KOD HS DNA polymerase (TOYOBO, Japan), and 0.5 μM each primer. phiX174 RF1 DNA was added as the target at a concentration of 12.5 copies/25 μL of reaction solution.

B. Microfluidic Device and System

A microfluidic device for performing PCR and capillary electrophoresis was prepared from an injection molded polycarbonate substrate and polycarbonate film (GE Plastics, 125 μm Lexan 8010), joined by lamination. The overall microfluidic device design is shown in FIG. 2, except that the design of first chamber 110, second chamber 116, chamber section 117, and connecting channel 115 is that shown in FIG. 3B. The overall dimensions of the device are about 45.5 mm×25.5 mm×5.5 mm. First chamber 110 has a depth of about 350 μm and a volume of about 18.9 μL. Second chamber 116 has a depth of about 350 μm and a volume of about 10 μL. Connecting channel 115 has a depth of about 80 μm, a width of about 98 μm, (cross-sectional area: about 7840 μm², aspect ratio: about 1.2), and a length of about 1.1 mm. The microfluidic channels in the device are each about 30 μm deep and 40 μm wide. The microfluidic device elements 120 (see FIG. 2) are described in U.S. patent application Ser. No. 14/395,239 by Liu et al. Electrodes were screen printed on the polycarbonate film prior to lamination, positioned to contact solution added to wells 1-10 (see FIG. 2) in the substrate/film laminated device.

The microfluidic device was prepared for operation as follows. Gel buffer, 200 mM TAPS buffer at pH 8 and 3.0 mM MgCl₂ was prepared. The capillary electrophoresis channel network was filled by adding a separation gel containing 3% polydimethylacrylamide sieving matrix in gel buffer to wells 3, 4, and 9. Focusing dye solution containing 0.2 μM 5-carboxytetramethylrhodamine in gel buffer was loaded into well 1. Gel buffer was loaded into well 7. CE marker solution containing Fermentas NoLimits DNA (15, 300, 500 bp; 1 ng/μL each) in gel buffer was loaded into well 8. The PCR reaction solution (˜35 μL) (Section A) was loaded into second load well 114 (also labeled well 6 in FIG. 2) and this solution filled the second load channel 113, first chamber 110, first load channel 111, and some of first load well 112 (also labeled well 5 in FIG. 2) by capillary action. Finally, 15 μL of 50 cst silicone fluid was added to first and second load wells 112 and 114 (wells 5 and 6).

The loaded microfluidic device was placed on a thermal cycling device consisting of a flat copper plate connected to a thermoelectric heater/cooler module (Model HV56, Nextreme, Durham, N.C.). A pressure manifold of the kind disclosed in U.S. patent application Ser. No. 12/600,171 to Li et al., which is incorporated herein by reference in its entirety, was contacted with the surface of the rims surrounding the wells of the microfluidic device making a pressure-tight seal over all the wells.

A gas pressure source comprising a syringe pump (volume 26 mL) and a valve (CKD Pneumatic USG2-M5) were arranged as described in connection with FIG. 10B and connected to the gas manifold for controlling the pressure over all the wells of the microfluidic device, included the first and second load wells. The operating pressures used in the mixing process were P_{high}=130 kPa, P_{low}=10 kPa. For transitions from P_{low} to P_{high}, the valve remained open, but for transitions from P_{high} to P_{low}, the valve was closed to isolate the gas manifold and microfluidic device before pulling the syringe plunger to create a low pressure in the syringe, and then the valve was opened to quickly expose the gas manifold to the lower pressure environment. During PCR thermocycles, the pressure in the gas manifold was held at P_{low}.

C. Assay Protocol

PCR was performed for 45 cycles, the reaction product was analyzed in the microfluidic device by capillary electrophoresis (CE), then the contents of first chamber 110 were mixed according to an embodiment of the invention, and finally the reaction product was analyzed again by CE. The experiment was repeated three times.

The PCR thermocycling protocol was performed with the following sequences of denaturing, annealing, and extension temperatures and times:

Cycle 1: 96° C. for 300 s, 60° C. for 14 s, and 74° C. for 8 s.

Cycle 2-13: 96° C. for 17 s, 60° C. for 14 s, and 74° C. for 8 s.

Cycle 14-45: 96° C. for 17 s, 60° C. for 14 s, and 74° C. for 39 s.

During cycles 14-45, CE analysis was conducted as described in U.S. patent application Ser. No. 14/395,239 by Liu et al.

Pressure pulse mixing was performed by increasing the pressure to P_{high} and decreasing it to P_{low}, for 30 cycles in a 250-second period, while holding the temperature of the thermal cycling device at 74° C.

Following the pressure pulse mixing step, the contents of the PCR assay solution were sampled again for CE analysis in the microfluidic device as described in U.S. patent application Ser. No. 14/395,239 by Liu et al.

D. Results

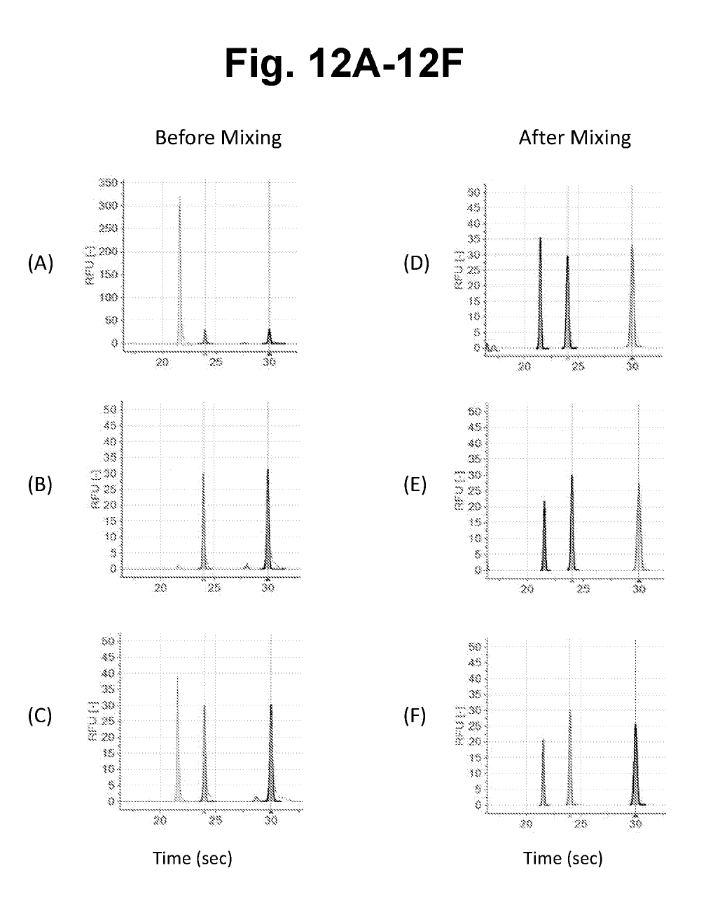

CE electropherograms for the three samples tested are shown in FIGS. 12A-12F. Electropherograms 12A-12C show the results for each of the three samples after PCR cycle 45 but before the assay solution in first chamber 110 was mixed. Electropherograms 12D-12F show the results for the respective samples after pressure pulse mixing was performed.

In the electropherograms, the PCR amplicon product peak (243 bp) appears at 22 sec, and two marker peaks (300 and 500 bp) appear at 24 sec and 30 sec.

It is evident from the electropherograms that analyzing the assay solutions before mixing leads to erratic results that do not accurately reflect the concentration of the product amplicon in the solution. For example, in FIG. 12A, the amplicon product peak is apparently present in much greater concentration then the marker DNA, and in FIG. 12B there appears to be a very small amount of amplicon product. However, after conducting the pressure pulse mixing step, each of these assay solutions are revealed in FIGS. 12D and 12E (respectively) to have similar amounts of amplicon product relative to the marker DNA. This indicates that the amplicon products were not evenly distributed in the assay solution immediately following thermal cycling, but, as a result of the pressure pulse mixing step, the products were more evenly distributed and thus the sample extracted from the first chamber for analysis was more representative of the assay solution contents.

### Example 2. PCR Assay with Mixing During Assay

A. PCR Primers and Target

The primers, target, and PCR assay solution of Example 1 was used.

B. Microfluidic Device and System

The microfluidic device and system of Example 1 was used.

C. Assay Protocol

Eight samples were prepared. PCR was performed for 45 cycles, where the reaction product was analyzed in the microfluidic device by capillary electrophoresis (CE) after each of the last 32 cycles. Four samples were analyzed without pressure pulse mixing the assay solution in the first chamber. Four samples were analyzed by mixing the assay solution for 2 minutes (30 mixing cycles, P_{high}=130 kPa, P_{low}=40 kPa) between PCR cycle 13 and 14.

The PCR thermocycling and pressure pulse mixing were performed with the following sequences of denaturing, annealing, and extension temperatures and times, and mixing protocol:

Cycle 1: 96° C. for 300 s, 60° C. for 14 s, and 74° C. for 8 s.

Cycle 2-13: 96° C. for 17 s, 60° C. for 14 s, and 74° C. for 8 s.

Mixing period: 95° C. for 120 s, with or without 30 cycles increasing the pressure to P_{high} and decreasing it to P_{low}.

Cycle 14-45: 96° C. for 17 s, 60° C. for 14 s, and 74° C. for 39 s.

During cycles 14-45, CE analysis was conducted as described in U.S. patent application Ser. No. 14/395,239 by Liu et al.

D. Results

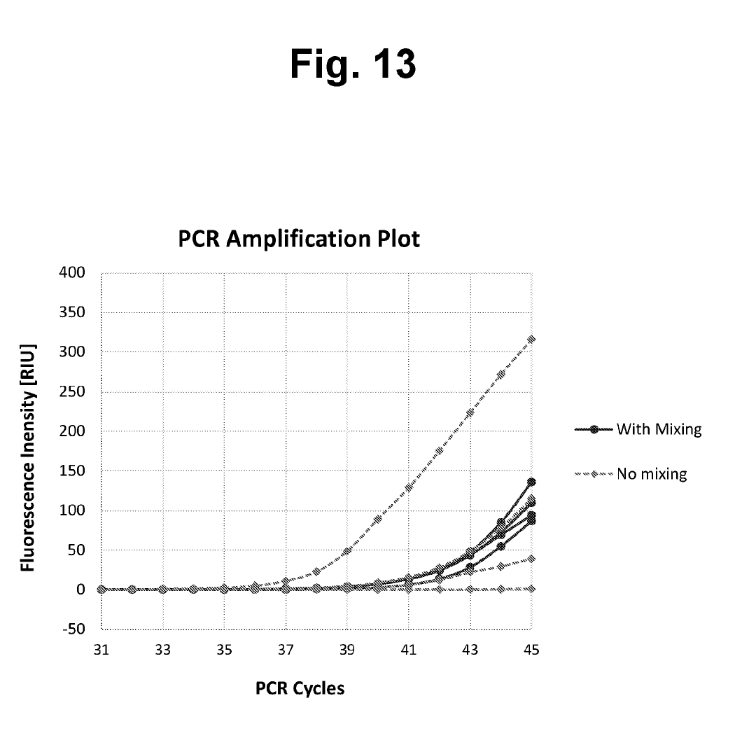

The results of the experiment are shown in FIG. 13, which plots the fluorescent intensity of the amplicon product versus the cycle number (cycles 31 to 45) for each sample. The growth curves for the control samples, which did not undergo pressure pulse mixing, are indicated by a dotted line, and the growth curves for samples that were mixed according to the methods disclosed herein are indicated by a solid line. The threshold cycle number (C_{q}), average C_{q} for samples giving a positive result, and the true positive rates observed for the two sets of samples are shown in Table 1 below.

TABLE 1

| | | | | | | True |
|---|---|---|---|---|---|---|
| Assay | | | | | | Positive |
| Protocol | Threshold Cycle Number (C_{q}) | | | | Avg. C_{q} | Rate |
| Mixing | 38.58 | 38.51 | 40.10 | 38.64 | 38.95 | 100% |
| No Mixing | 38.50 | — | 40.19 | 35.30 | 37.99 | 75% |

By mixing the assay solution in the course of the PCR amplification protocol (between cycle 13 and 14), the growth curves subsequently observed demonstrate much greater uniformity and reproducibility than the samples that were amplified without a mixing step.

By mixing the samples in the early phase of the PCR assay, it appears that the development of reaction zone hot spots was minimized and/or the amplicons at that intermediate point were more homogeneously distributed, and this lead to a more uniform distribution of product and a more uniform sampling of the assay solution in the later cycles. In contrast, samples that were not mixed gave results ranging from a much earlier threshold cycle number (C_{q}) of ˜35.3, suggesting a much higher concentration of target in the sample to a negative result where the product was not detected.

The results of this experiment also demonstrate that pressure pulse mixing yields a more even distribution of low concentration components and thus can provide samples from microfluidic chambers that are more representative of the solution contents.

Although the invention has been described with respect to particular embodiments and applications, those skilled in the art will appreciate the range of devices, systems, and methods of the invention described and enabled herein.

1. A microfluidic device comprising:
a first chamber;
a first load channel that leads from the first chamber to a first load well;
a second load channel that leads from the first chamber to a second load well;
a second chamber;
a connecting channel that leads from the first chamber to the second chamber; and
a capillary electrophoresis channel network connected to the first chamber;
wherein:
the first chamber volume is between 1 μL and 1 mL;
the connecting channel cross-sectional area is between 0.001 mm² and 0.12 mm²;
the second chamber is at least 0.1 and at most 1.5 times the volume of the first chamber, and the second chamber is only in fluidic communication with the connecting channel.

2. The microfluidic device according to claim 1, wherein (the second chamber fill ratio) x (the second chamber volume) is less than two times the lesser of (i) the volume of the first load channel plus the first load well and (ii) the volume of the second load channel plus the second load well, and the second chamber fill ratio is at least 0.2 and at most 0.99.

3. The microfluidic device according to claim 1, wherein (the second chamber fill ratio) x (the second chamber volume) is less than sum of (i) the volume of the first load channel plus the first load well plus (ii) the volume of the second load channel plus the second load well.

4. The microfluidic device according to claim 1, wherein the first chamber volume is between 2 μL and 100 μL.

5. The microfluidic device according to claim 1, wherein the second chamber is at least 0.2 and at most 0.95 times the volume of the first chamber.

6. The microfluidic device according to claim 1, wherein the second chamber fill ratio is at least 0.5 and at most 0.7.

7. The microfluidic device according to claim 1, wherein the connecting channel cross-sectional area is between 0.002 mm² and 0.06 mm².

8. (canceled)

9. A method for causing mixing a solution in a first chamber in a microfluidic device, the method comprising:
providing a microfluidic device according to claim 1;
adding solution, via the first load well, into the first load well, the first load channel, the first chamber, the second load channel, and the second load well;
increasing the gas pressure to a pressure P_{high} over the first load well and the second load well; and
decreasing the gas pressure to a pressure P_{low} over the first load well and the second load well;
wherein P_{low} is equal to or greater than atmospheric pressure and less than P_{high};
whereby the increasing and decreasing gas pressure steps cause mixing of the solution in the microfluidic device.

10. The method according to claim 9, wherein the gas pressure increasing step and gas pressure decreasing step are repeated alternately at least 2 times.

11. The method according to claim 9, wherein in the gas pressure increasing step, the maximum gas pressure applied is in the range of 50 to 200 kPa.

12. The method according to claim 9, wherein in the gas pressure decreasing step, the gas pressure is lowered to 0 to 180 kPa.

13. The method according to claim 9, wherein in the gas pressure increasing step, the rate of increase is between 20 kPa/sec and 1500 kPa/sec.

14. The method according to claim 9, wherein in the gas pressure decreasing step, the rate of decrease is between 50 kPa/sec and 1500 kPa/sec.

15. The method according to claim 9, wherein after the step of adding solution and before the step of increasing the gas pressure, a water-immiscible fluid is placed on top of the solution in the first load well and the second load well.

16. (canceled)

17. The method according to claim 9, the method further comprising:
disposing a gas manifold block over the first and second load wells and sealing the gas manifold block against the microfluidic device, and increasing or decreasing the gas pressure in the gas manifold block causes the gas pressure over the first load and the second load well to increase or decrease.

18. The method according to claim 17, wherein after the step of adding solution and before the step of disposing a gas manifold block, a water-immiscible fluid is placed on top of the solution in the first load well and the second load well.

19. (canceled)

20. A microfluidic device system comprising:
(i) a microfluidic device comprising:
a first chamber;
a first load channel that leads from the first chamber to a first load well;
a second load channel that leads from the first chamber to a second load well;
a second chamber; and
a connecting channel that leads from the first chamber to the second chamber;
wherein:
the first chamber volume is between 1 μL and 1 mL;
the connecting channel cross-sectional area is between 0.001 mm² and 0.12 mm²;
the second chamber is at least 0.1 and at most 1.5 times the volume of the first chamber, and the second chamber is only in fluidic communication with the connecting channel; and
(the second chamber fill ratio) x (the second chamber volume) is less than two times the lesser of (i) the volume of the first load channel plus the first load well and (ii) the volume of the second load channel plus the second load well, and the second chamber fill ratio is at least 0.4 and at most 0.99; and
(ii) a gas manifold block comprising a first surface having at least one opening therein, a port on the outer surface of the gas manifold block that is not within the at least one opening, and a channel within the gas manifold block connecting the port to each of the at least one opening in the first surface, wherein the at least one opening in the first surface of the gas manifold block is disposed over the first and second load wells of the microfluidic device.

21. The microfluidic device system according to claim 20, further comprising:
a source of pressurized gas;
a valve comprising a first opening and a second opening;
a first tube coupling the pressurized gas source to the first valve opening; and
a second tube coupling the second valve opening to gas manifold block port.

22. (canceled)

23. The microfluidic device system according to claim 21, further comprising a microprocessor configured to control the increase and decrease of the pressure in the gas manifold block by controlling the source of pressurized gas and/or the valve; and optionally further comprising a temperature-controllable surface adapted to receive the microfluidic device.

24. (canceled)

25. The microfluidic device system according to claim 20, the microfluidic device further comprising:
a capillary electrophoresis channel network connected to the first chamber; and
electrodes in the microfluidic device configured for electrophoretic analysis in the capillary electrophoresis channel network;
the system further comprising:
a power supply operatively connected to the electrodes in the microfluidic device.


SEQUENCE LISTING (2 sequences)

SEQ ID NO: 1 - DNA, 20 bp, Artificial Sequence
  primer
cgttggatgaggagaagtgg

SEQ ID NO: 2 - DNA, 18 bp, Artificial Sequence
  primer
acggcagaagcctgaatg